(19) United States
(12) Patent Application Publication
(10) Pub. No.: US 2023/0237532 A1
(43) Pub. Date: Jul. 27, 2023

(54) PLATFORM FOR ACCELERATING SALES BY PERSONALIZING USER INTERACTIONS BASED ON USER BEHAVIOR

(71) Applicant: Kaydu, Inc., Redwood City, CA (US)

(72) Inventors: Ruben Ruvalcaba Chalita, Aguasclaientes (MX); Flavio Salvador de la Fuente Zamora, Aguascalientes (MX); Juan Carlos Feregrino Quezada, Aquascalientes (MX); Jimmer Andres Alba Gutierrez, Aguascalientes (MX)

(73) Assignee: Kaydu, Inc., Redwood City, CA (US)

(21) Appl. No.: 18/160,273

(22) Filed: Jan. 26, 2023

Related U.S. Application Data
(60) Provisional application No. 63/303,035, filed on Jan. 26, 2022.

(51) Int. Cl. G06Q 30/0251; G06Q 30/0202

(52) U.S. Cl. CPC G06Q 30/0271; G06Q 30/0255; G06Q 30/0202

(57) ABSTRACT

Disclosed herein is a platform utilizing data processing to accelerate sales by personalizing user interactions based on user behavior. Network-based sales platforms allow merchants to offer goods or services to customers online. However, existing technical solutions may lack the functionality that allows determining what goods and services would be of interest to a particular customer. The lack of such functionality may result in low conversion rates. As a result of the poor conversion rates, merchants incur unnecessary expenses in blanket advertising to customers who are unlikely to buy the advertised goods and services.

### CROSS REFERENCE TO RELATED APPLICATIONS

This application claims the priority benefit of U.S. Provisional Application No. 63/303,035, filed Jan. 26, 2022, entitled “PLATFORM FOR ACCELERATING SALES BY PERSONALIZING USER INTERACTIONS BASED ON USER BEHAVIOR”.

### TECHNICAL FIELD

The present disclosure relates generally to data processing, and more specifically to a platform for accelerating sales by personalizing user interactions based on user behavior.

### BACKGROUND

Network-based sales platforms allow merchants to offer goods or services to customers online. However, existing technical solutions may lack the functionality that allows determining what goods and services would be of interest to a particular customer. The lack of such functionality may result in low conversion rates. As a result, merchants may incur expenses in blanket advertisement to customers who are unlikely to buy the advertised goods and services.

### BRIEF DESCRIPTION OF THE DRAWINGS

Embodiments are illustrated by way of example and not limitation in the figures of the accompanying drawings, in which like references indicate similar elements.

FIG. 1 is a block diagram of an environment, in which systems and methods for accelerating sales by personalizing user interactions based on user behavior can be implemented, according to some example embodiments.

FIG. 2 is a system for accelerating sales by personalizing user interactions based on user behavior, according to some example embodiments.

FIGS. 3-5 are example screens of CRM, according to some example embodiments.

FIGS. 6-7 are example screens of an email marketing module, according to some example embodiments.

FIGS. 8-11 are example screens of a popup marketing module, according to some example embodiments.

FIGS. 12-14 are example screens of an automation module, according to some example embodiments.

FIGS. 15-17 are example screens of an ecommerce module, according to some example embodiments.

FIG. 18 is an example screen of a sales accelerating platform, according to some example embodiments.

FIG. 19 is a flow chart of a method for accelerating sales by personalizing user interactions based on user behavior.

FIG. 20 shows a computing system that can be used to implement a system and a method for accelerating sales by personalizing user interactions based on user behavior.

FIG. 21 illustrates a mechanism to create landing pages within the email marketing module.

FIG. 22 shows a page tracking the traffic through a given landing page.

FIG. 23 is a screen facilitating the establishment of landing pages, either from a library of standard templates or with customization package.

FIGS. 24-28 illustrate the screens used to build and customize the landing pages.

FIG. 29 shows a preview tool for the landing pages.

FIG. 30 shows an analytics page.

FIG. 31 illustrates a search engine optimization page.

FIG. 32-34 shows the screens that facilitate communication with a third party communications package.

FIG. 35 is an example of a template generation for a page connecting to a third party communications package.

FIGS. 36 and 37 illustrate an exemplary page for the third party package.

FIGS. 38 and 39 show an exemplary inbox system for the third party package.

FIGS. 40 and 41 show an exemplary notification system for the third party package.

FIGS. 42 and 43 illustrate a methodology to convert the third party communications to the format of the system disclosed herein.

FIGS. 44 and 45 illustrate an administration page for the system.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides methods and systems for accelerating sales by personalizing user interactions based on user behavior. Unlike existing marketing software (e.g., marketing automation), embodiments of the present disclosure may provide a sales platform that allow faster progression from determining a good of interest to a user (“a lead”) to the sales process, and various steps in between.

The sales accelerating platform disclosed herein allows utilizing popups to accelerate user journey to lead conversion, ultra-personalized automation, ultra-personalized events, and e-commerce section. This process provides for faster travel in the stages of sales processing.

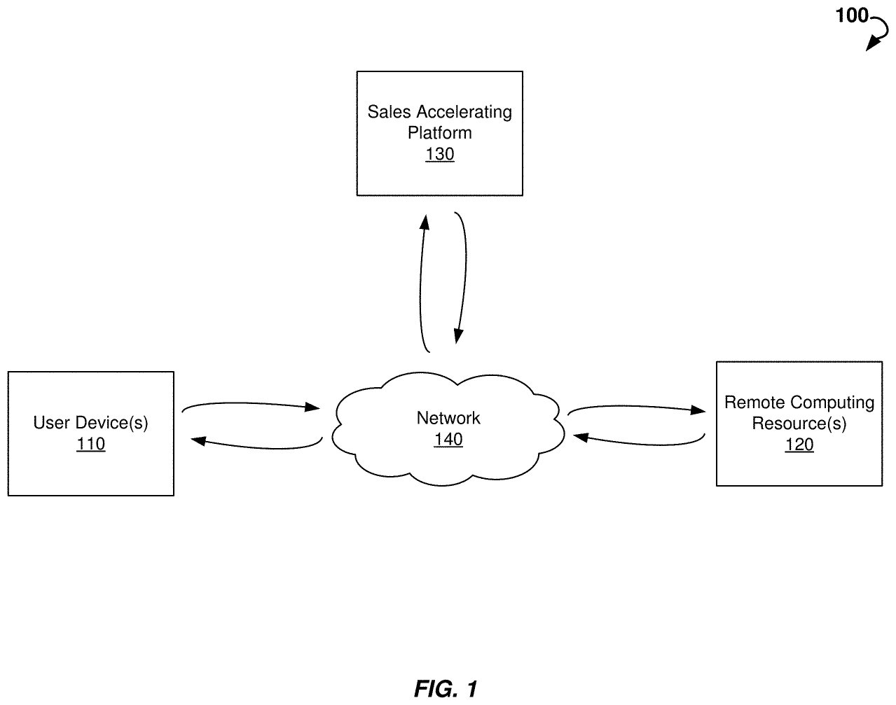

Referring now to the drawings, FIG. 1 is a block diagram of environment 100, in which systems and methods for accelerating a sales funnel by personalizing customer interactions can be implemented, according to some example embodiments. The environment 100 may include one or more user device(s) 110, one or more remote computing resource(s) 120, a network 140, and sales acceleration platform 130.

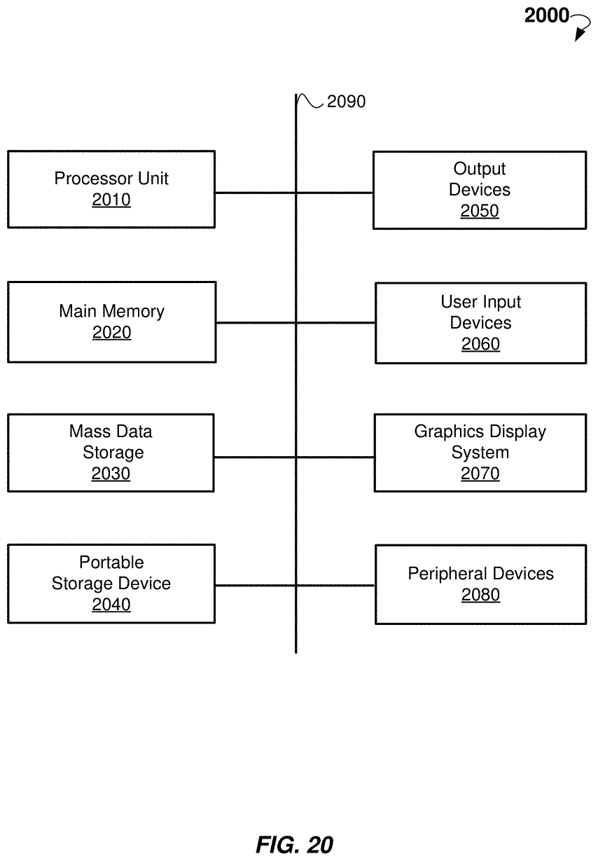

The user device(s) 110, remote computing resource(s) 120, sales acceleration platform 130 each can be a standalone computing system or a combination of computing system forming a computing cloud. An example computing system is described in FIG. 20.

The network 140 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including WiFi™, 4G/LTE/5G, Bluetooth™, Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network 140 can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

The remote computing system(s) 120 may provide one or more websites. Users of the user device(s) 110 may access one or more website(s) via the network 140. The sales acceleration platform 130 may map a process workflow for a purchase funnel using a plurality of templates. The templates may include a trigger condition and a personalized action corresponding to the trigger condition. The templates may include landing pages, checkout pages, upsell product offerings, and cross-sell product offerings.

The sales acceleration platform 130 may further track user behavior to determine that the trigger condition has been satisfied. The user behavior can be tracked by creating an anonymous user assigned a user identifier. The user identifier may include one of the following: an IP, browser identifier, and database identifier. The user behavior may include, for example, reading an email, opening an item, engaging in a communication, and clicking on an item.

Based on the determination that the trigger condition has been satisfied, the sales acceleration platform 130 may trigger the personalized action in the form of a popup or an email offering the user one or more products. The sales acceleration platform 130 may receive a user choice of a product offer and launch an ecommerce section. The sales acceleration platform 130 may collect user payment information and finalize a sale of the at least one product offer.

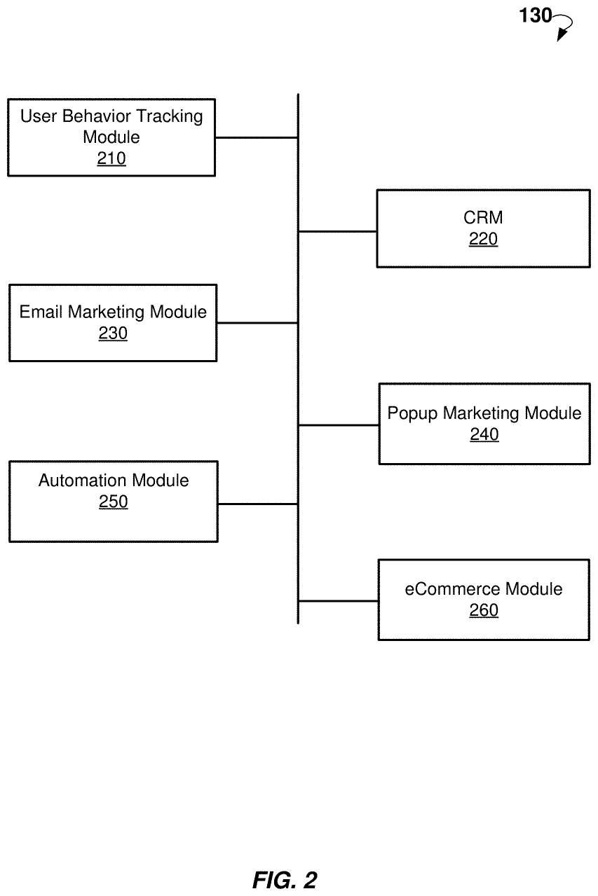

FIG. 2 shows modules of the sales accelerating platform 130, according to some example embodiments. The sales acerating platform 130 may include a user behavior tracking module 210, a customer relationship management (CRM) module 220, an email marketing module 230, a popup marketing module 240, an automation module 250, and an ecommerce module 260.

The user behavior tracking module 210 can create anonymous users and track behavior of the anonymous users. Each of the anonymous users can be assigned an identifier (ID) based on Internet protocol (IP) address, browser, database, and so forth. In one example embodiment, every time the anonymous user accesses a particular website from the same computer, the module 210 tracks this information. This information can be later used to present a popup offer to the user based on preferences of the anonymous user.

For example, a user may access a website of a wine company that markets white, red, and sparkling wines. Normally popups are shown to everybody accessing webpages. According to an embodiment of present disclosure, the user behavior tracking module 210 first tracks the behavior of the users and generates a popup customized based on the user behavior. For example, if module 210 determines that the user is more interested in red wine, the module 210 shows a popup with red wine, based on what the user is more likely to be interested in. Thus, users accessing the same website may be shown popups with offers of different products according to their preferences, for example, a white wine, a sparkling wine, and so forth.

Once the anonymous user provides personal information, for example, by filling out an opt-in form, the module 210 can assign a name and number to the anonymous user. Thereafter, the module 210 may present offers by, for example, sending emails to the user. The process of converting the offers can be accelerated because the offers are targeted to specific users. For example, offers of red wine are shown to users interested in red wine and offers of white wine are shown to users interested in white wine. Thus, users can be divided into different baskets, for example, “white wine” basket, “red wine basket”, and so on.

The CRM 220 can manage deals and sales for users. The deals can be managed both automatically and manually based on user behavior. Deals can be rearranged when a particular user has performed a particular action: visited a certain price webpage, attended an online seminar, watched a video online, downloaded a video, and so forth.

Promotions can be automated based on statistics associated with user behavior. For example, a user may have visited a particular webpage showing products for more than 3 minutes and 2 times pricing pages for each product. Based on this information, a lead score can be calculated for a certain offer. If the lead score exceeds a predetermined threshold (for example, 80 form 100), the offer can be presented to the user. The offer can be sent via email or presented via a popup when the user accesses a particular website.

The email marketing module 230 may allow designing an email message to be presented with a particular offer of a product. The email message can be sent to one or more users once a certain triggering event occurs, for example, when a lead score for this particular offer exceeds a predetermined threshold for a particular user or a group of users.

The popup marketing module 240 may allow designing a popup message presenting a particular offer of a product. The popup can be shown to a particular user when the particular user opens a particular webpage in an Internet browser. The popup can be shown when the lead score for the offer exceeds a predetermined threshold for this particular user or a group of users.

The automation module 250 may allow setting conditions on sending emails or presenting popups with offers. The conditions can include events, such as a user has visited a particular website or a lead score for a certain offer exceeds a predetermined threshold. The lead score can be determined for a particular user based on the user behavior, such as visiting a certain webpage, attending an online seminar, watching video online, downloading a video, and so forth.

Once the user accepts an offer, the user can be redirected to the ecommerce section provided by ecommerce module 260. Unlike a conventional shopping cart, the user is redirected to a payment screen having only one product (the main product) to expedite shopping process. The payment screen does not show any extra products before the user buys the main product. Offering any extra products prior to the purchase of the main product may lead to a combined price that exceeds the user's budget and causes the user to leave the payment screen. Thus, the ecommerce module 260 may only show the extra product to the user after the user has paid for the main product.

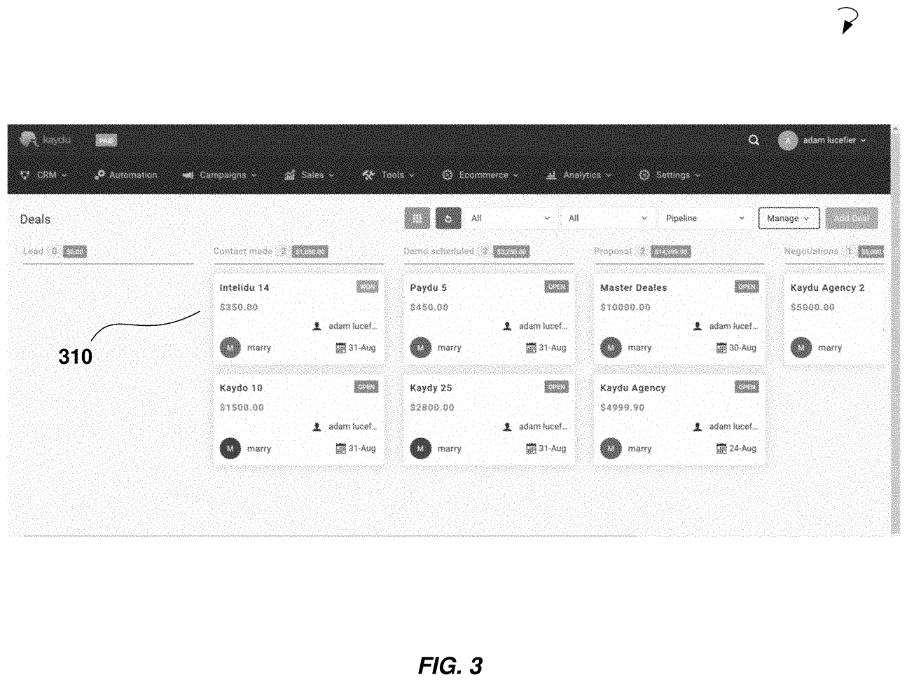

FIG. 3 is an example screen 300 of the CRM 210, according to some example embodiments. The screen 300 includes a pipeline of deals 310. The deals 310 can be rearranged either automatically or manually.

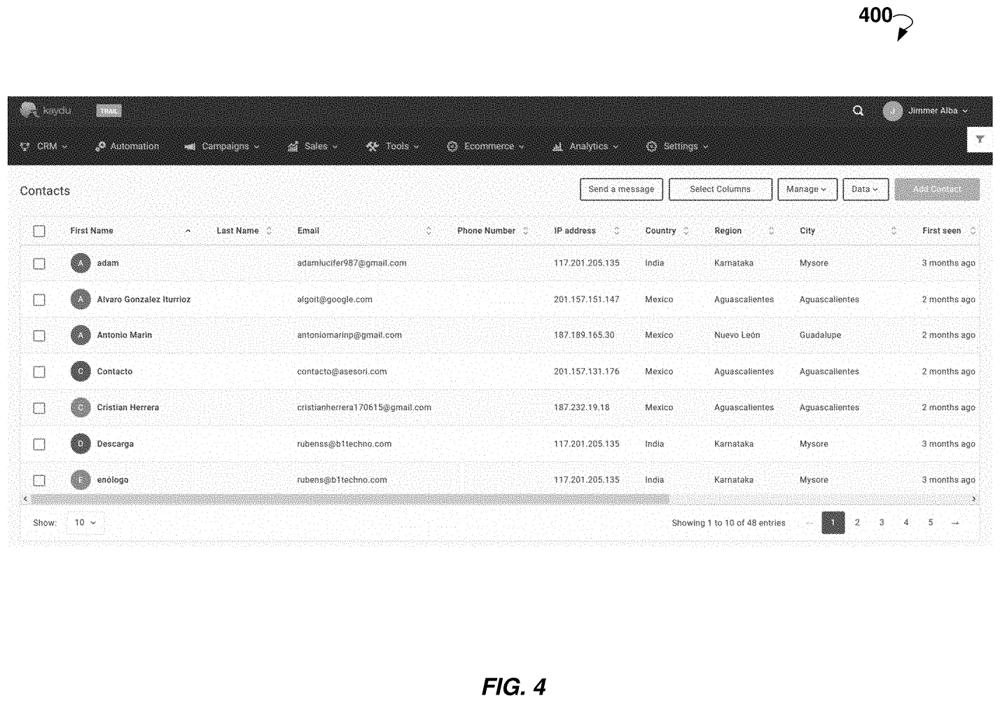

FIG. 4 is an example screen 400 of the CRM 210, according to some example embodiments. The screen 400 shows a list containing information concerning users. The screen 400 allows selecting a particular user from the list.

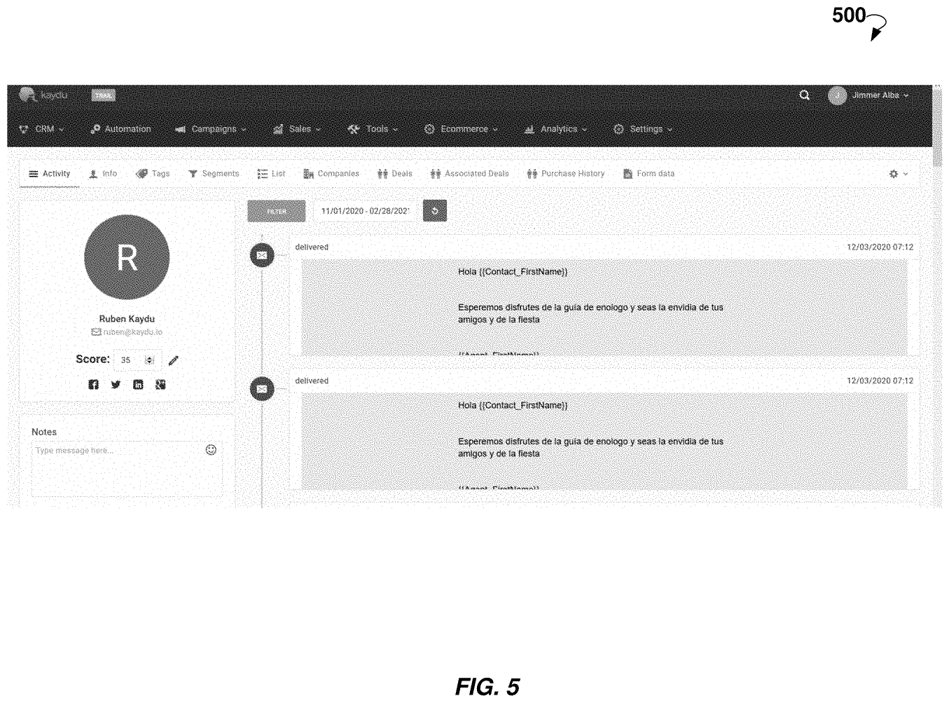

FIG. 5 is an example screen 500 of the CRM 210, according to some example embodiments. The screen 500 allows reviewing data for a specific user. Specifically, the screen 500 allows reviewing user behaviors like emails sent, files open, visited pages, images open or send, document downloads, videos watched, and so forth. The user data can be combined using IP, browser data, database accessed by the user, and so forth. Unidentified users would not have an email and name in the data. Once the user is identified, the name and email address are added to the data.

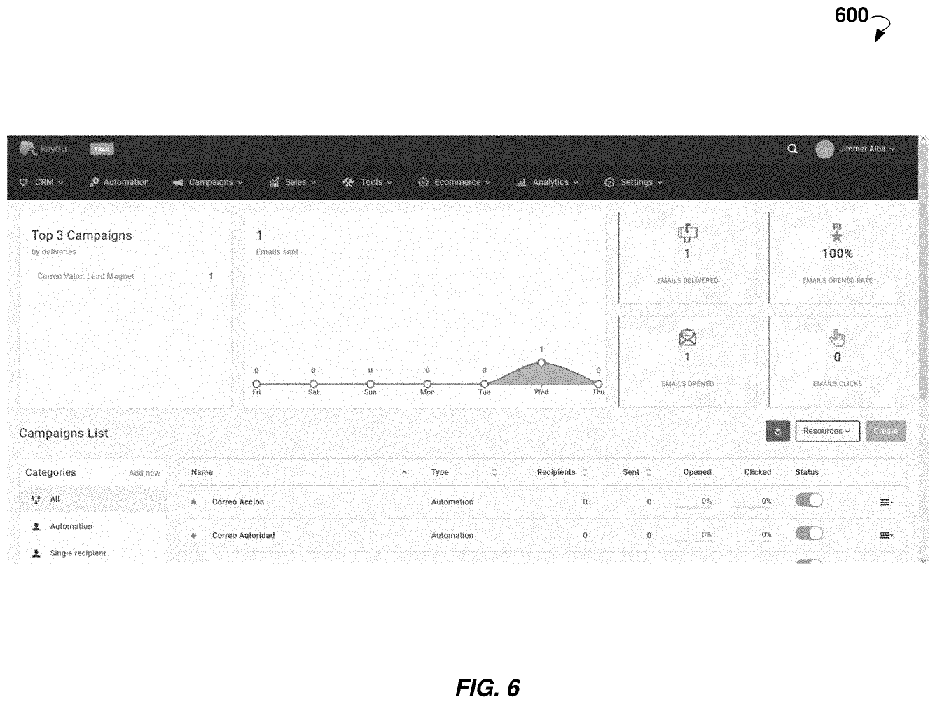

FIG. 6 is an example screen 600 of the email marketing module 230, according to an example embodiment. This screen 600 allows creating regular email campaigns like sending mass email. Instead of sending all emails at once, the emails are sent one by one to avoid spam filters. These emails can be sent to everyone on a distribution list. In some embodiments, the emails can be personalized for a particular user or group of users. The emails can be sent to users associated with a particular tag, like a “red wine”, a “white wine”, and so forth.

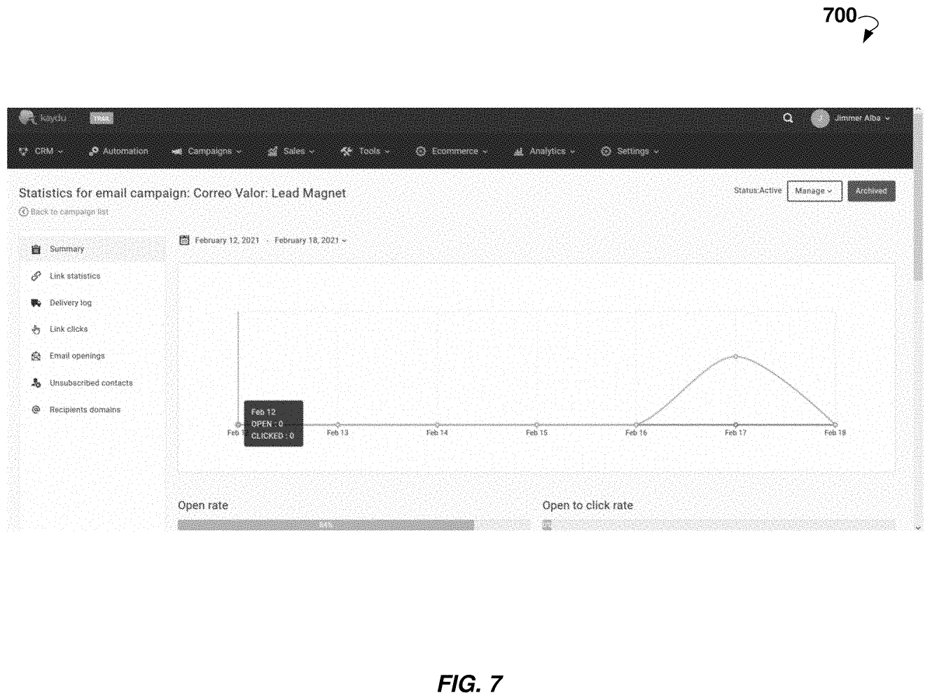

FIG. 7 is an example screen 700 of the email marketing module 230, according to an example embodiment. The screen 700 shows analytics concerning specific email campaigns. The analytics may include clicked links, open rates, delivery rates, email openings, unsubscribed users, sent domains, and so forth.

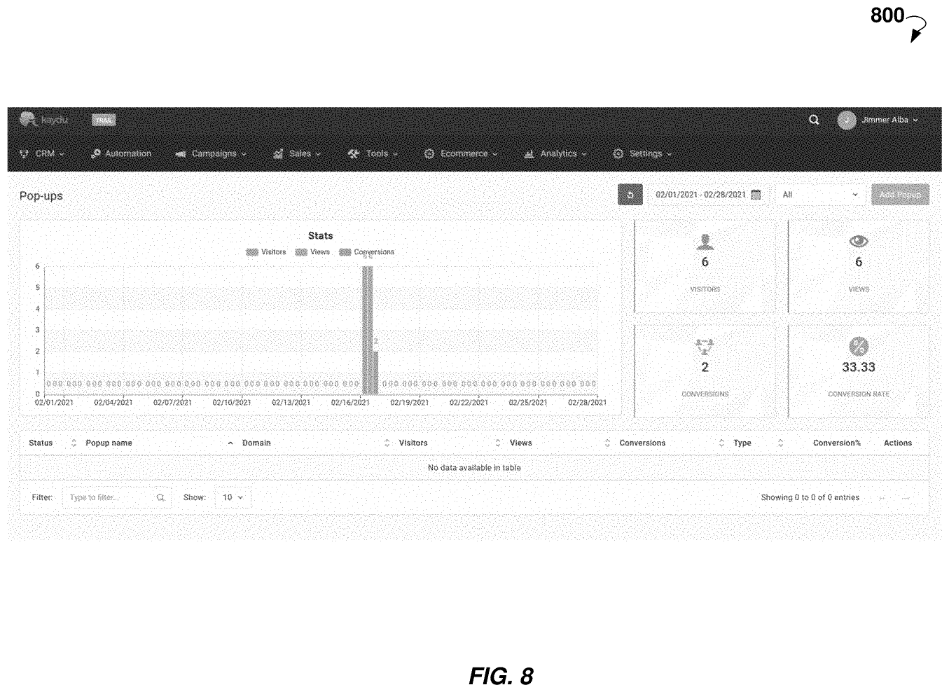

FIG. 8 is an example screen 800 of the popup marketing module 240, according to an example embodiment. The screen 800 allows creating leads, generating popups, and training popups. The popups can be on a personal level allowing for more effective targeting of potential customers (leads).

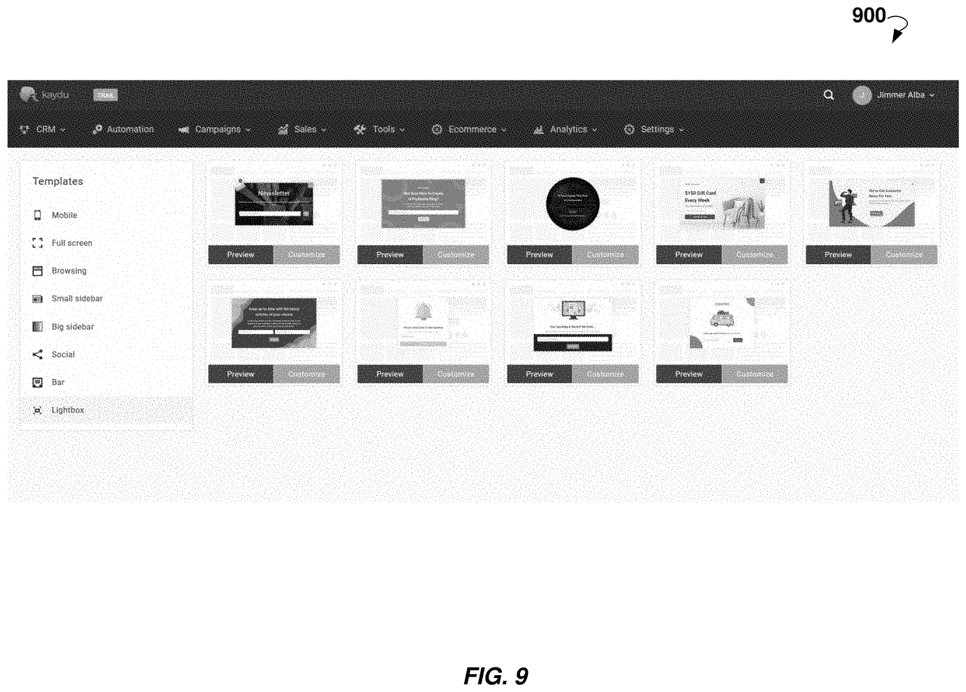

FIG. 9 is an example screen 900 of the popup marketing module 240, according to an example embodiment. The screen 900 allows selecting a popup from templates, and formatting and customizing the selected popup.

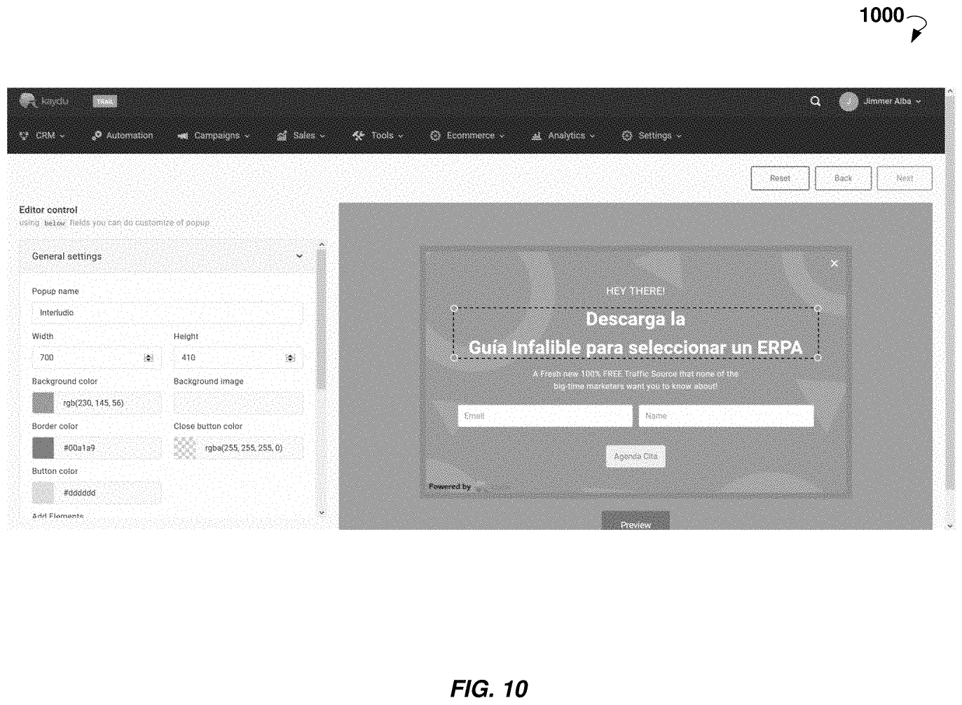

FIG. 10 is an example screen 1000 of the popup marketing module 240, according to an example embodiment. The screen 1000 allows editing design of popup to include specific brand and content.

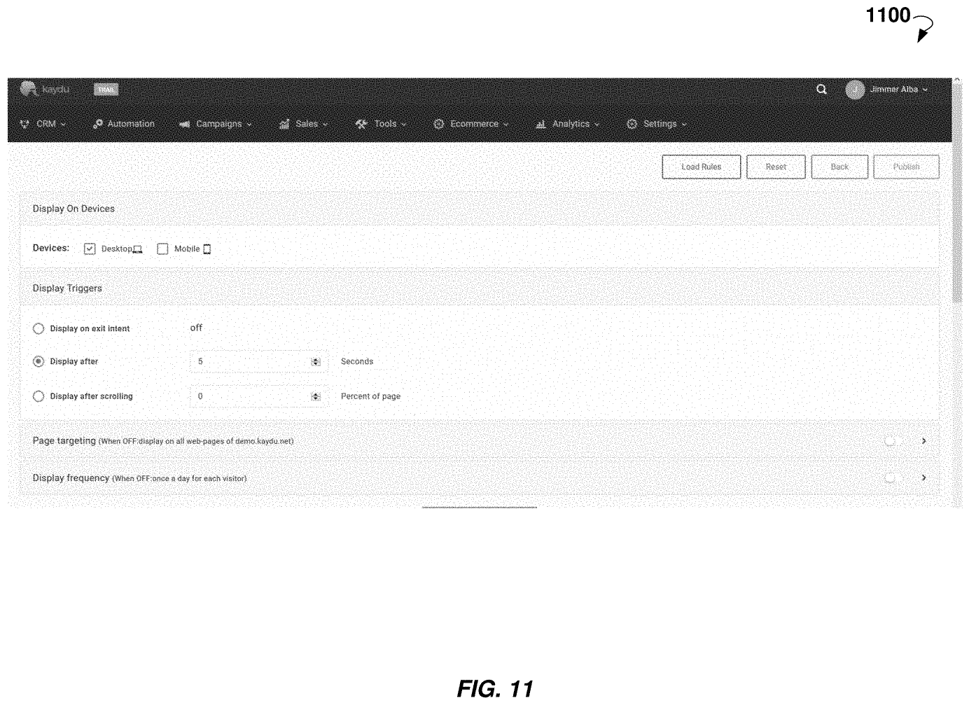

FIG. 11 is an example screen 1100 of the popup marketing module 240, according to an example embodiment. The screen 1100 allows assigning trigger conditions to popups to make each of the popups specific and personal to particular users.

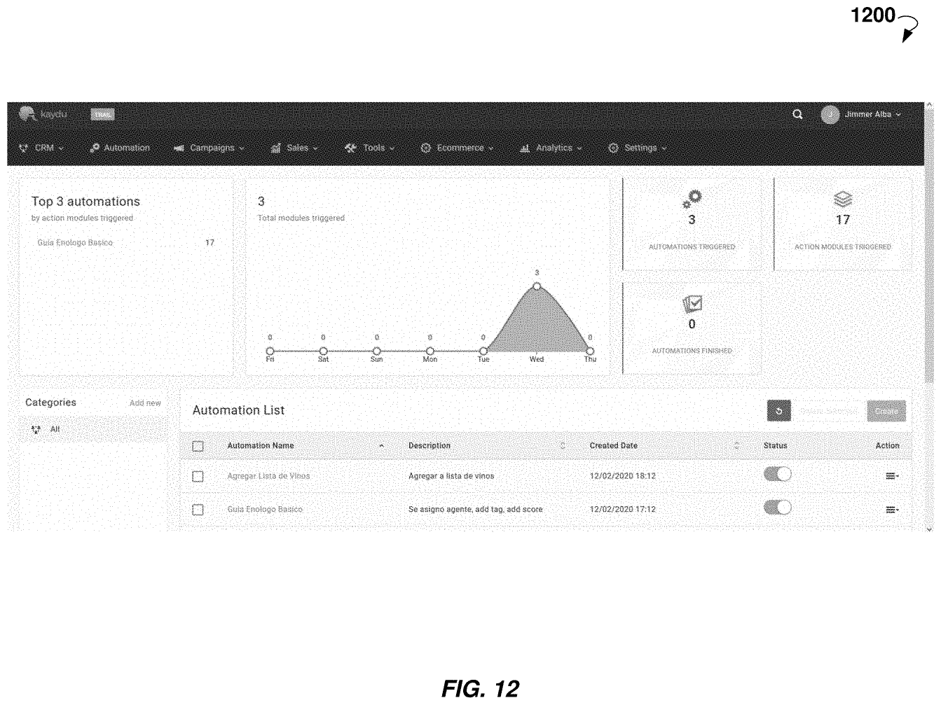

FIG. 12 is an example screen 1200 of the automation module 250, according to an example embodiment. The screen 1200 allows triggering automatic actions depending on user actions. The screen 1200 allows mapping the process of sales.

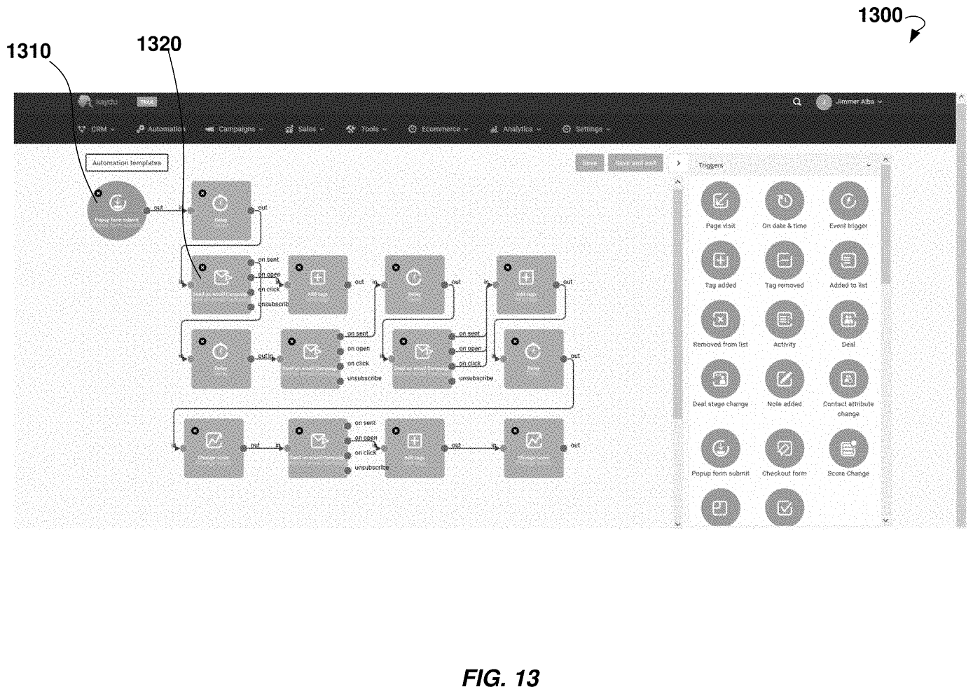

FIG. 13 is an example screen 1300 of the automation module 250, according to an example embodiment. The screen 1300 shows a design center allowing mapping process to run automatically. The design center allows adding triggers, conditions and actions to personalize process for all users or a particular user. The circles 1310 may represent triggers and the rectangles 1320 may represent conditions and actions.

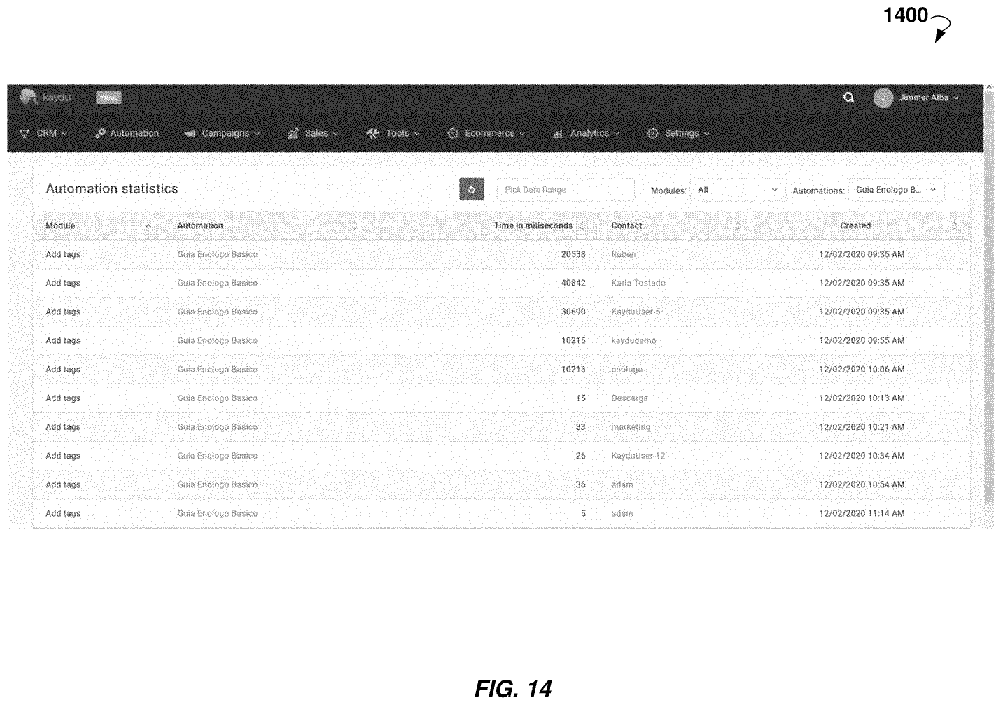

FIG. 14 is an example screen 1400 of the automation module 250, according to an example embodiment. The screen 140 depicts a list of actions of automated process. The automation module 250 allows tracking all and each actions of each automation process. Thus, the automation module 250 may allow evaluation of each process and determining the points where the processes are stopped. If a process is stopped, the automation module 250 may optimize the process.

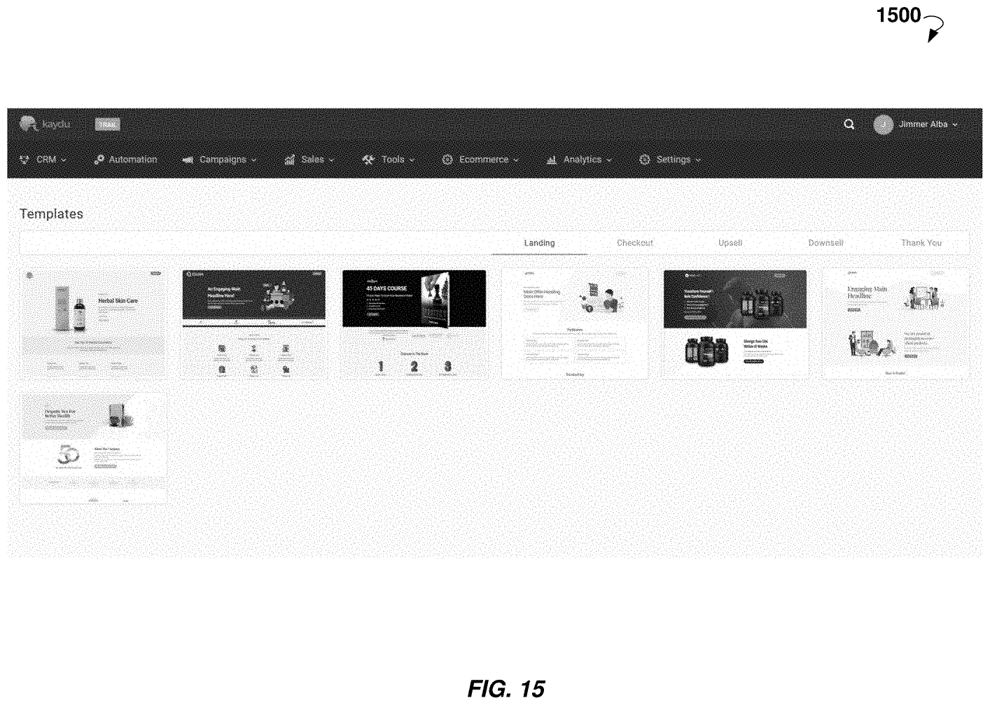

FIG. 15 is an example screen 1500 of the ecommerce module 260, according to an example embodiment. In the screen 1500, the ecommerce module 260 may allow selecting templates for product landing pages, checkout pages, upsells, downsells, thank you pages, and connecting the pages with online payment platforms (for example, PayPal, stripe, 2checkout, and others). The module 260 is based on sales funnels. The module 260 may allow managing templates, products (fiscal, digital, memberships, etc.), funnels, customers, and manage orders. The module 260 performs analytics related to online sales.

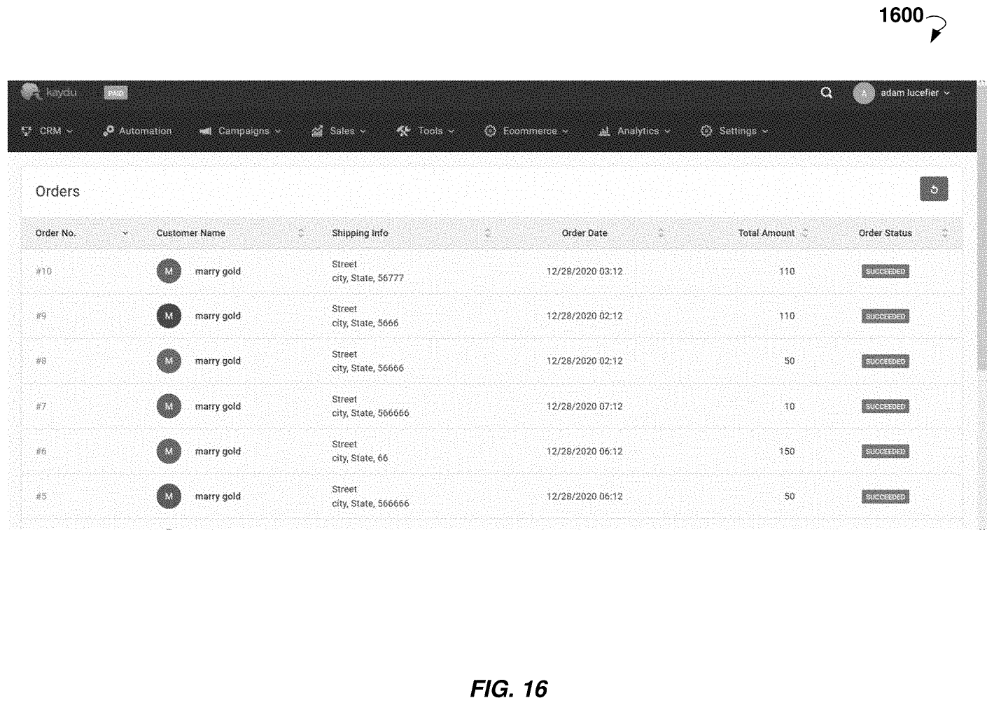

FIG. 16 is an example screen 1600 of the ecommerce module 260, according to an example embodiment. In the screen 1600, the ecommerce module 260 may allow managing data concerning orders and refunds.

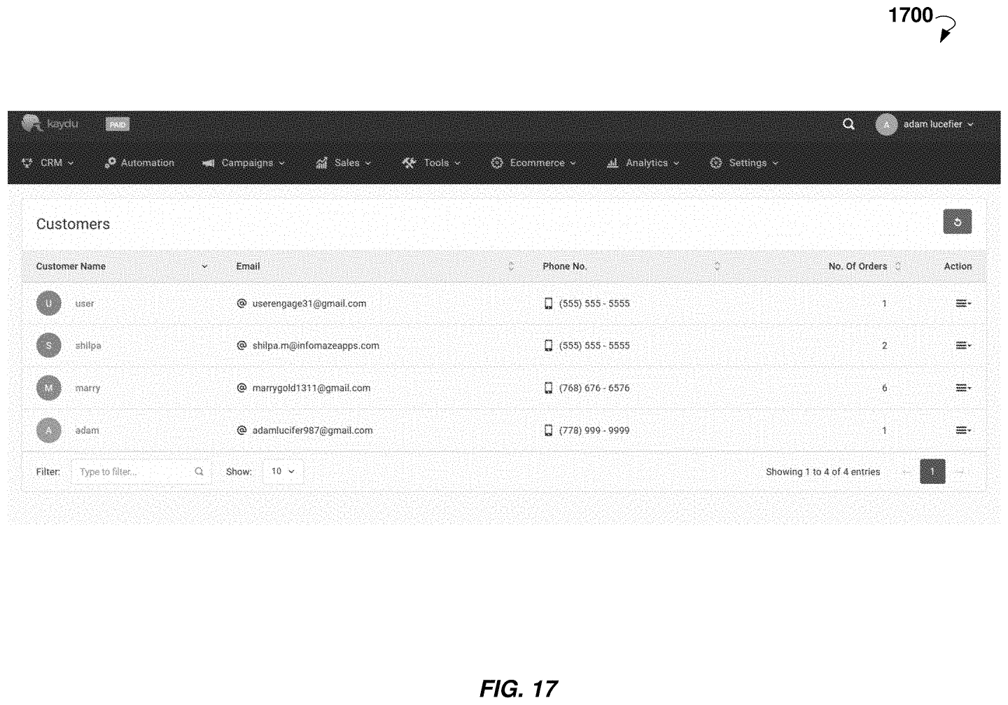

FIG. 17 is an example screen 1700 of the ecommerce module 260, according to an example embodiment. In the screen 1700, the ecommerce module 260 may allow managing data related to customers, purchase orders, history of orders, and general information.

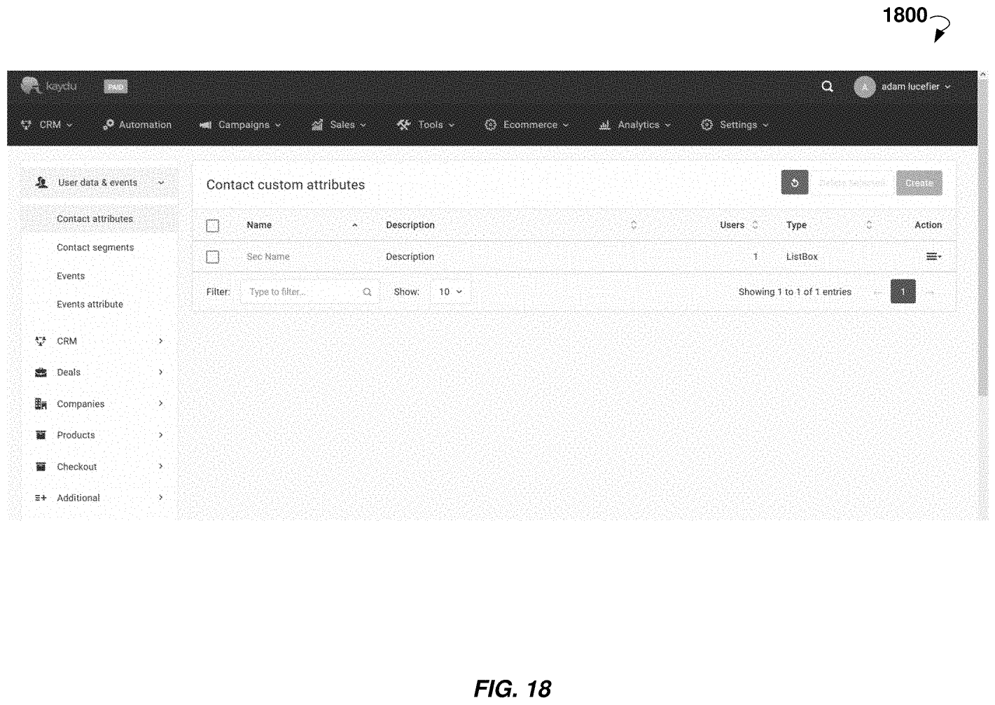

FIG. 18 is an example screen 1800 of the sales accelerating platform 130, according to an example embodiment. In the screen 1800, the sales accelerating platform 130 may allow managing the configurations of business rules and business logic.

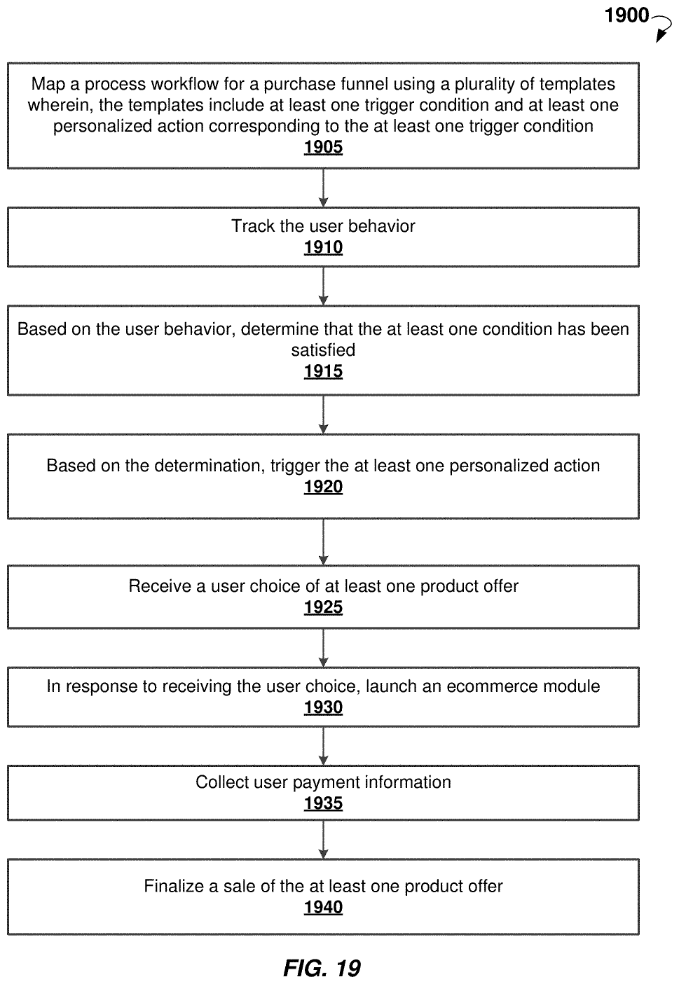

FIG. 19 is a flow chart of a method 1900 for accelerating sales by personalizing user interactions based on user behavior. The method 1900 may commence at block 1905 with mapping a process workflow for a purchase funnel using a plurality of templates. The templates may include at least one trigger condition and at least one personalized action corresponding to the trigger condition. The plurality of templates may include popup adds, design popups, customers, brands, and text. The templates include landing pages, checkout pages, upsell product offerings, and cross-sell product offerings.

In block 1910, the method 1900 may proceed with tracking the user behavior. Tracking of the user behavior can include creating an anonymous user associated with a user identifier where the identifier may include one or more of the following: IP, browser identifier, and database identifier. The user behavior can include reading an email, opening an item, engaging in a communication, and clicking on an item.

In block 1915, the method 1900 may proceed with determining, based on the user behavior, that the condition has been satisfied and, if the condition is satisfied, in block 1920, the method can proceed with triggering a personalized action. The personalized action can include one or more of the following: communicating a message, displaying a product, displaying a lead generating popup, generating an email, moving the user to the ecommerce section, performing analytics, generating an event, tracking an event, and exchanging data with the CRM.

In block 1925, the method 1900 may proceed with receiving a user selection of at least one product offer. In block 1930, the method 1900 may, in response to receiving the user choice, launch an ecommerce section. In block 1935, the method 1900 may collect user payment information, and in block 1940, the method 1900 may finalize a sale of the at least one product offer.

The method 1900 may further include providing a further product offer for sale. The further product offer can be related to the at least one product offer where the user is able to purchase the at least one product offer using the user payment information collected at the sale of the product.

The method 1900 may further include collecting user information by having the user fill out a form. The method may then associate, based on the collected user information, the user with a name and email address. The method 1900 may also include integrating the user and corresponding user information into the CRM. The method may then periodically email at least one offer to users with emails randomized to avoid spam filters.

The method 1900 may further include analyzing user response to the emails. The analysis may include analyzing clicked links, open rates, delivery rates, email openings, unsubscribed users, and sent domains. The method 1900 may further include selecting from a popup templates and formats and customizing and dynamically personalizing popups. The method 1900 may further include tracking user behavior after actions are executed, receiving feedback, and optimizing the process based on the received feedback.

FIG. 20 illustrates an exemplary computer system 2000 that may be used to implement some embodiments of the present invention. The computer system 2000 of FIG. 20 may be implemented in the contexts of the likes of computing systems, networks, servers, or combinations thereof. The computer system 2000 of FIG. 20 includes one or more processor units 2010 and main memory 2020. Main memory 2020 stores, in part, instructions and data for execution by processor units 2010. Main memory 2020 stores the executable code when in operation, in this example. The computer system 2000 of FIG. 20 further includes a mass data storage 2030, portable storage device 2040, output devices 2050, user input devices 2060, a graphics display system 2070, and peripheral devices 2080.

The components shown in FIG. 20 are depicted as being connected via a single bus 2090. The components may be connected through one or more data transport means. Processor unit 2010 and main memory 2020 is connected via a local microprocessor bus, and the mass data storage 2030, peripheral device(s) 2080, portable storage device 2040, and graphics display system 2070 are connected via one or more input/output (I/O) buses.

Mass data storage 2030, which can be implemented with a magnetic disk drive, solid state drive, or an optical disk drive, is a non-volatile storage device for storing data and instructions for use by processor unit 2010. Mass data storage 2030 stores the system software for implementing embodiments of the present disclosure for purposes of loading that software into main memory 2020.

Portable storage device 2040 operates in conjunction with a portable non-volatile storage medium, such as a flash drive, floppy disk, compact disk, digital video disc, or Universal Serial Bus (USB) storage device, to input and output data and code to and from the computer system 2000 of FIG. 20. The system software for implementing embodiments of the present disclosure is stored on such a portable medium and input to the computer system 2000 via the portable storage device 2040.

User input devices 2060 can provide a portion of a user interface. User input devices 2060 may include one or more microphones, an alphanumeric keypad, such as a keyboard, for inputting alphanumeric and other information, or a pointing device, such as a mouse, a trackball, stylus, or cursor direction keys. User input devices 2060 can also include a touchscreen. Additionally, the computer system 2000 as shown in FIG. 20 includes output devices 2050. Suitable output devices 2050 include speakers, printers, network interfaces, and monitors.

Graphics display system 2070 include a liquid crystal display (LCD) or other suitable display device. Graphics display system 2070 is configurable to receive textual and graphical information and processes the information for output to the display device.

Peripheral devices 2080 may include any type of computer support device to add additional functionality to the computer system.

The components provided in the computer system 2000 of FIG. 20 are those typically found in computer systems that may be suitable for use with embodiments of the present disclosure and are intended to represent a broad category of such computer components that are well known in the art. Thus, the computer system 2000 of FIG. 20 can be a personal computer (PC), handheld computer system, telephone, mobile computer system, workstation, tablet, phablet, mobile phone, server, minicomputer, mainframe computer, wearable, Internet of things device/system, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

The processing for various embodiments may be implemented in software that is cloud-based. In some embodiments, the computer system 2000 is implemented as a cloud-based computing environment, such as a virtual machine operating within a computing cloud. In other embodiments, the computer system 2000 may itself include a cloud-based computing environment, where the functionalities of the computer system 2000 are executed in a distributed fashion. Thus, the computer system 2000, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 2000, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

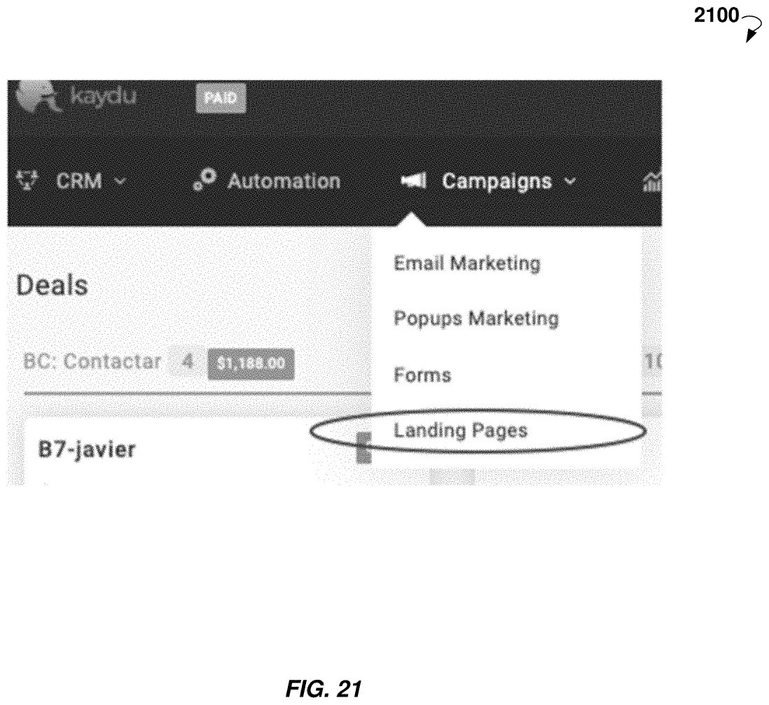

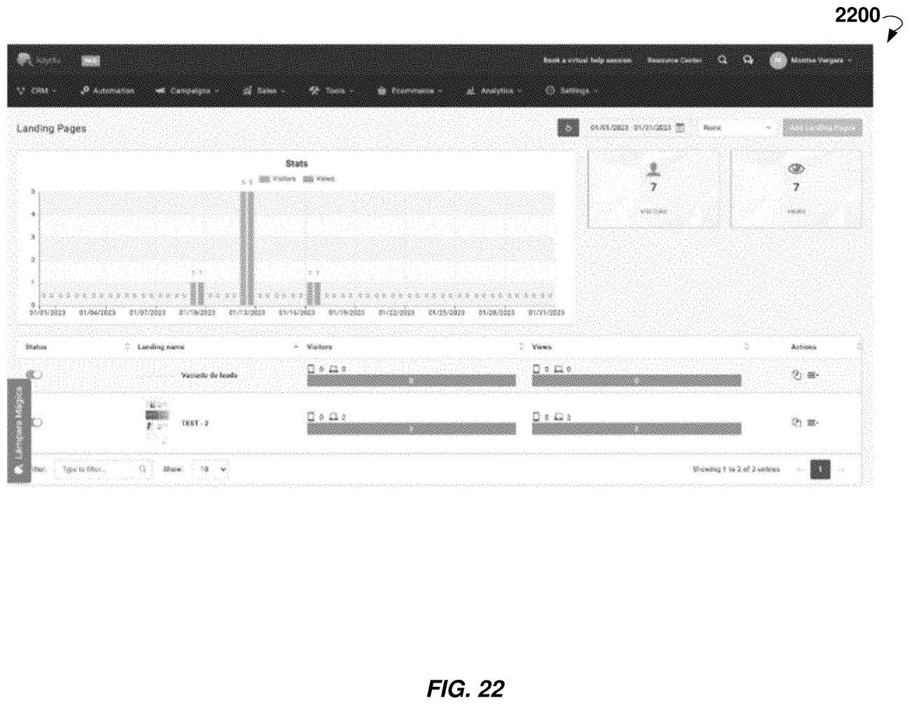

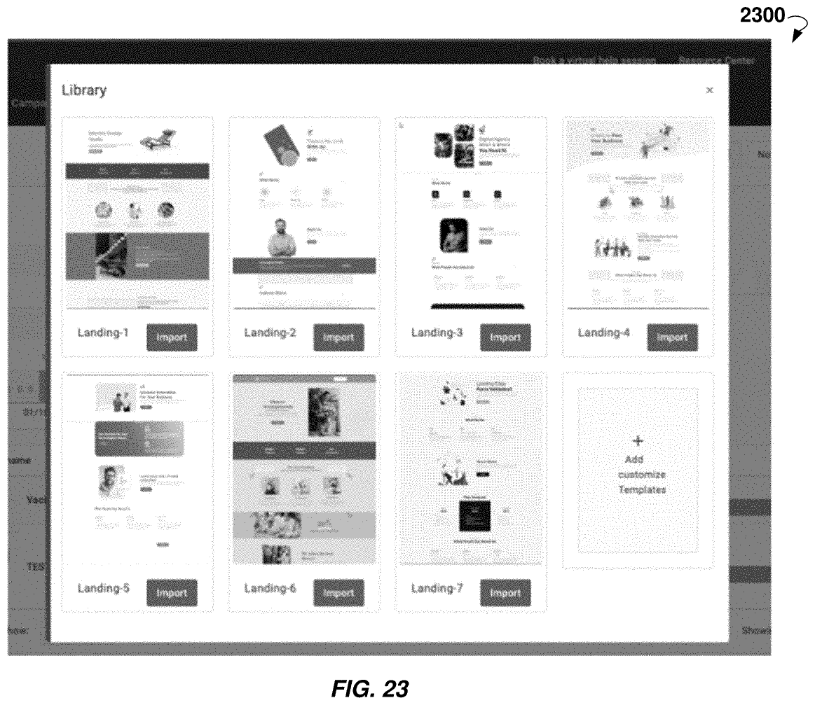

FIGS. 21 and 22 illustrate a mechanism to create landing pages within the email marketing module 230 of the sales platform 130. As illustrated in FIG. 23, the platform 130 further includes a module 2300 to establish the various landing pages to be used in selected marketing strategies. The module 2300 structure is similar to that used for the form and popup features described previously. The process begins by the platform 130 creating and tracking graphs and numbers representing the traffic experienced on selected landing pages.

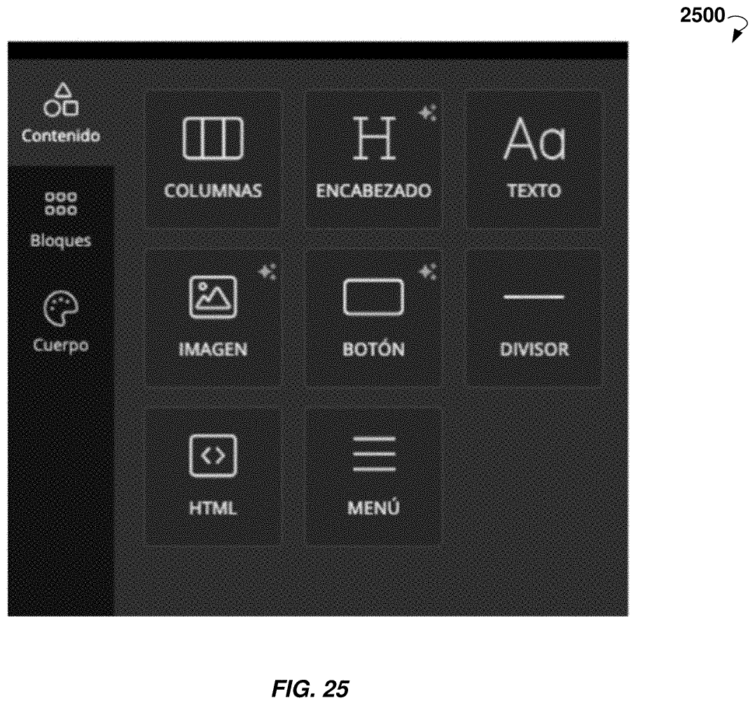

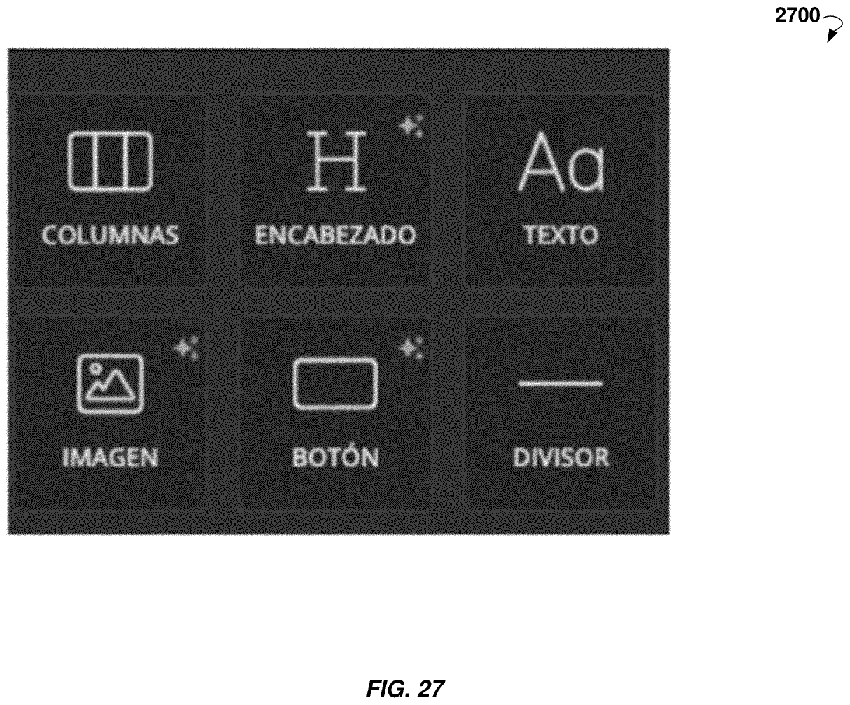

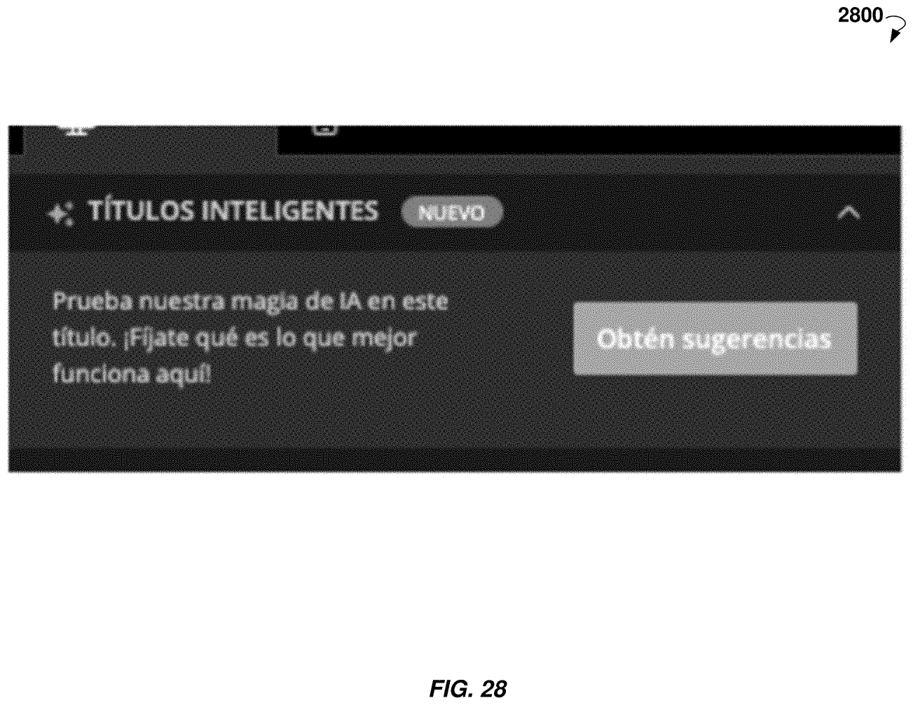

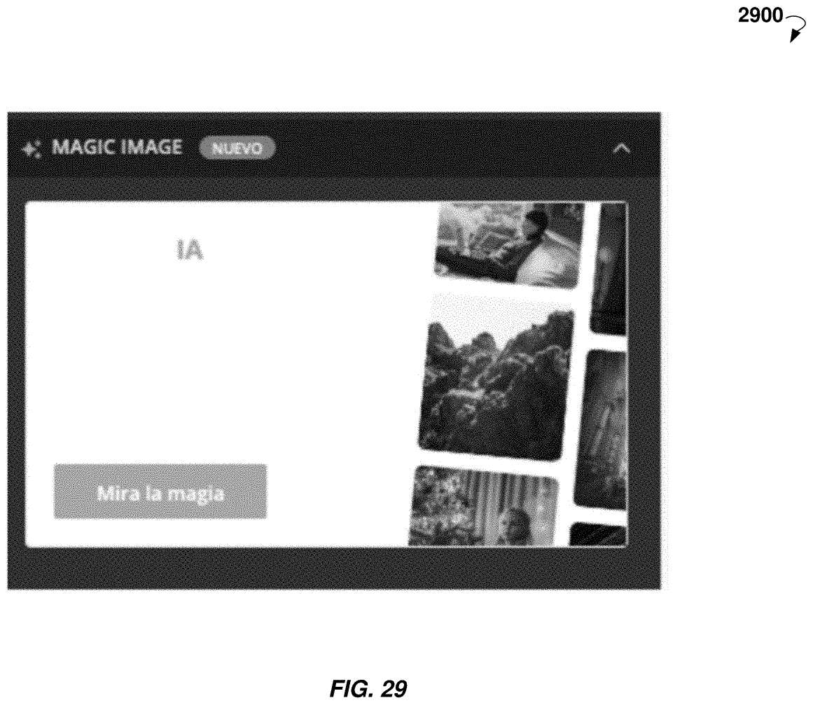

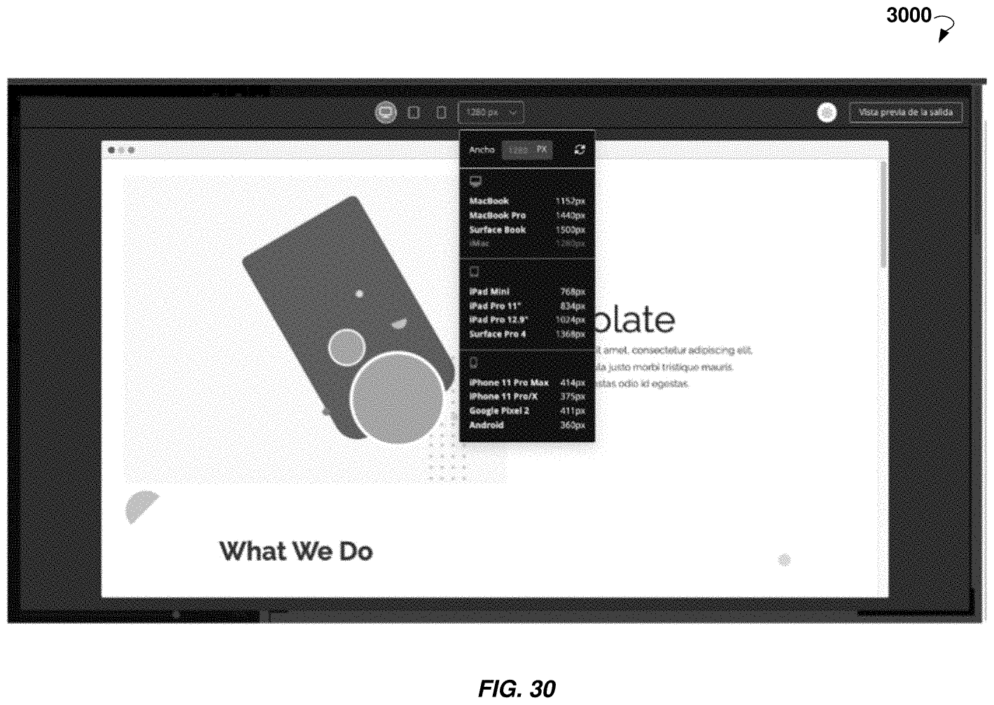

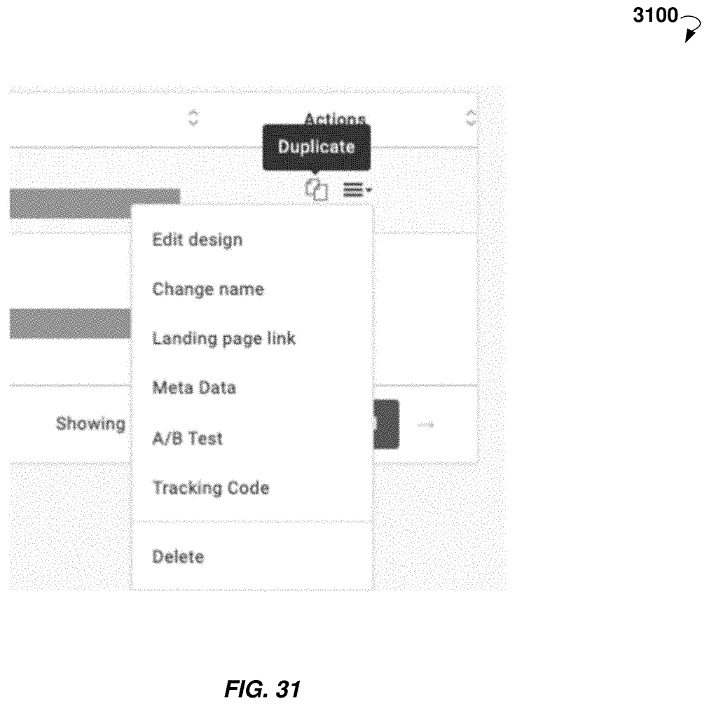

To create a landing page in the platform 130, a user can select one of a number of pre-established template options. In various embodiments, seven templates are provided to the user. As an alternative, a user can choose to create a landing page not listed among the pre-defined templates. Once the user selects a template, the platform 130 will show the user a landing page construction/editing package. In various embodiments, the construction/editing package is called Unlayer. Some components of the construction/editing package are shown in FIGS. 23-28. The construction/editing package includes specialized software to build this type of digital asset and is known to those skilled in the art. The specialized software is integrated into the platform 130.

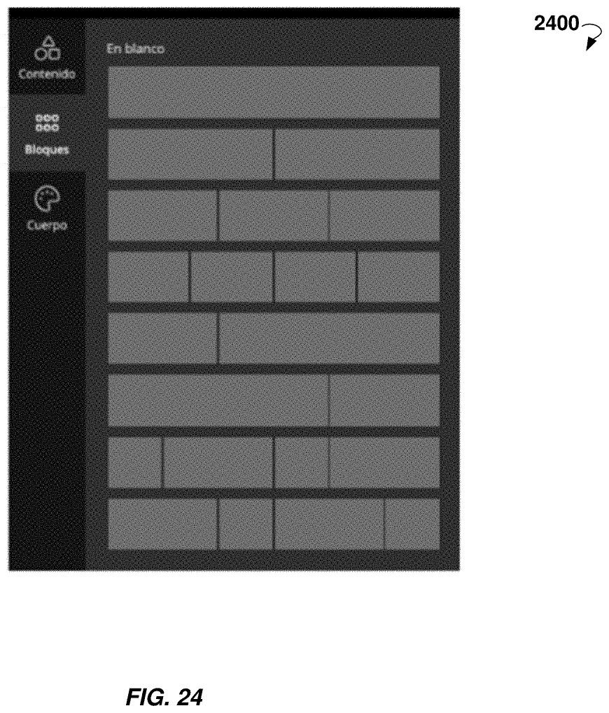

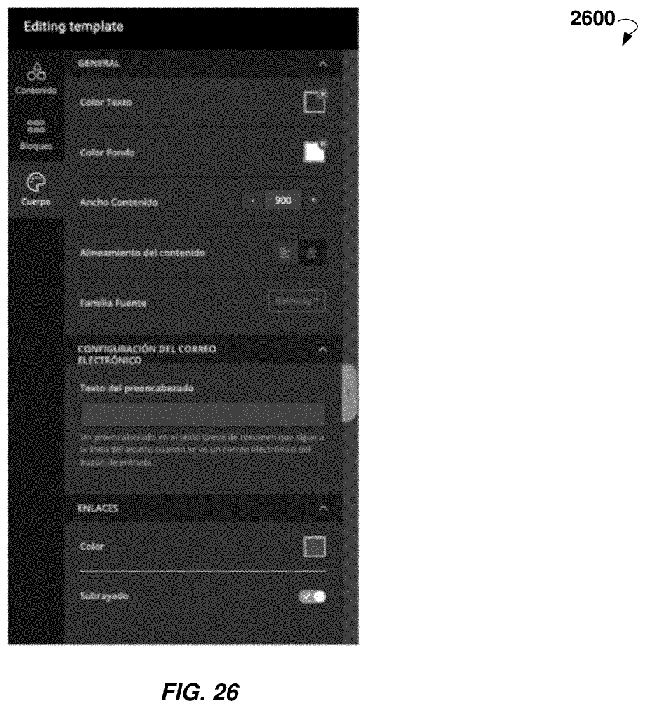

Landing Page Construction. Within the construction/editing package, we have the creation/edition options 2400 for the landing pages on the left sidebar. See FIG. 24. First, the user chooses a container. A container is a piece in which different elements will be positioned that will shape the landing page. After the container is established, elements (second option on the sidebar) are established in the container to give body to the landing page, and may include images, titles, text blocks, buttons, HTML content, dividers, columns, menus, etc. The third option in the sidebar shown in FIG. 24 refers to all the general elements of the landing page, such as background color, text color, spacing for text, etc. An exemplary editing template is illustrated in FIG. 26.

One of the advantages of the selected construction/editing package is that it provides an intelligent creation tool for various text elements. One of the functions of this tool is that it uses artificial intelligence to give us title options, prompts for specific actions, and also may initiate searches or creation of images from a word or sentence.

Once the landing page is designed, a preview tool 2900 can evaluate how your published landing page will appear to visitors. This is very useful as it allows users of the platform 130 to evaluate design themes on various devices.

Once the landing page is finished, within its settings you can obtain the URL. Also, if third party software packages are used for analytics, such as Facebook Pixel or Google Analytics, the user has the option of using the third party codes. In the same way, a user can configure metadata that helps SEO (search engine optimization) strategies and even run A/B tests (evaluation of alternative strategies) to evaluate which is the best strategy to adopt in a given situation.

Being able to build landing pages directly from the platform 130 (the entire system is commercially named “Kaydu”) is that a user can generate a complete lead capture strategy and store all relevant information directly in the platform 130, without any need to use other types of software.

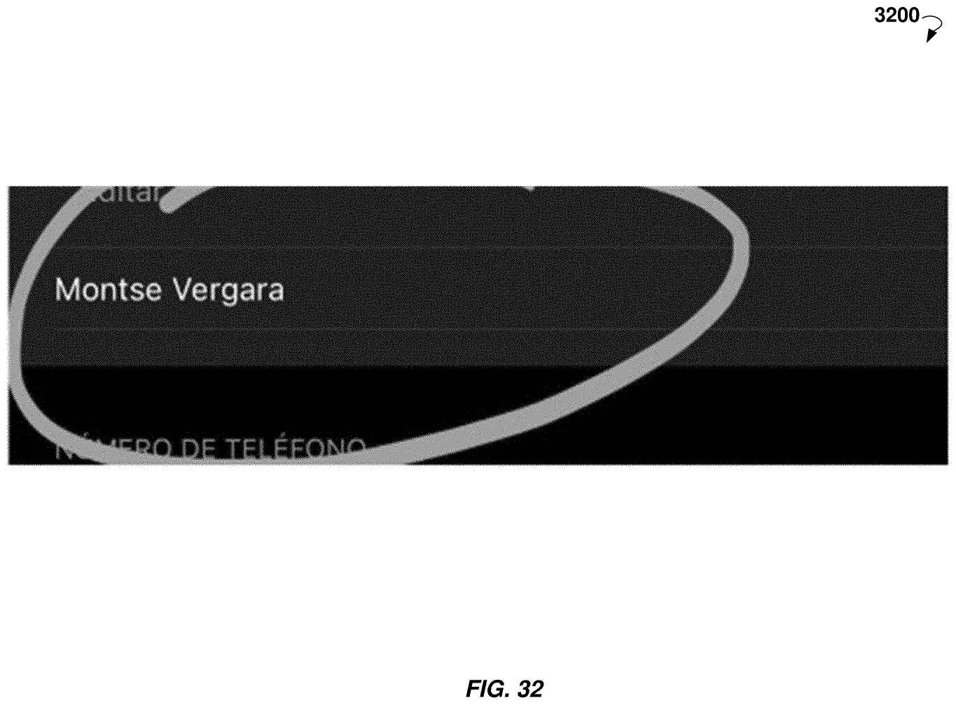

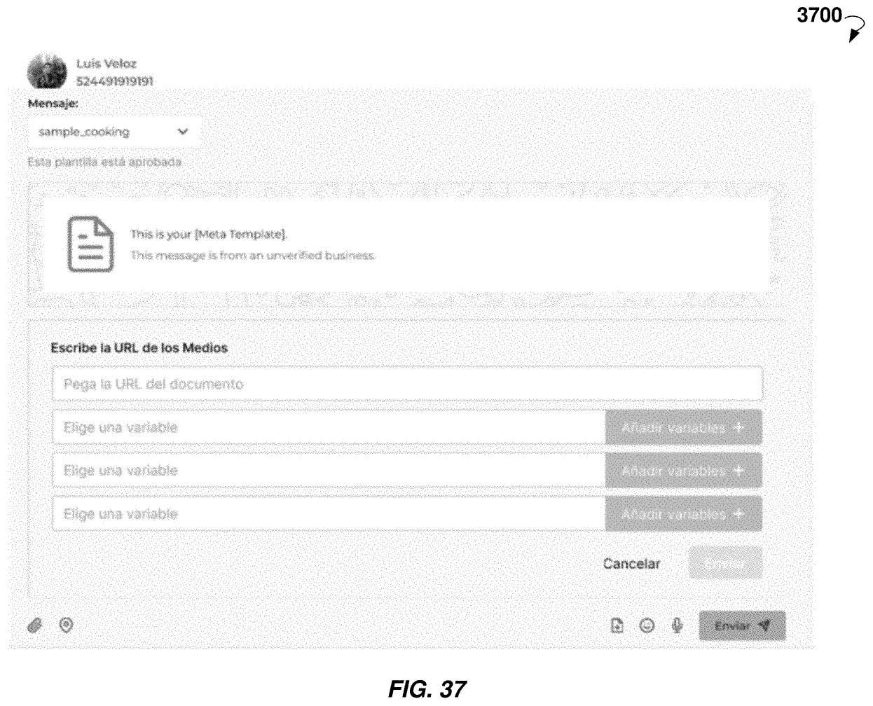

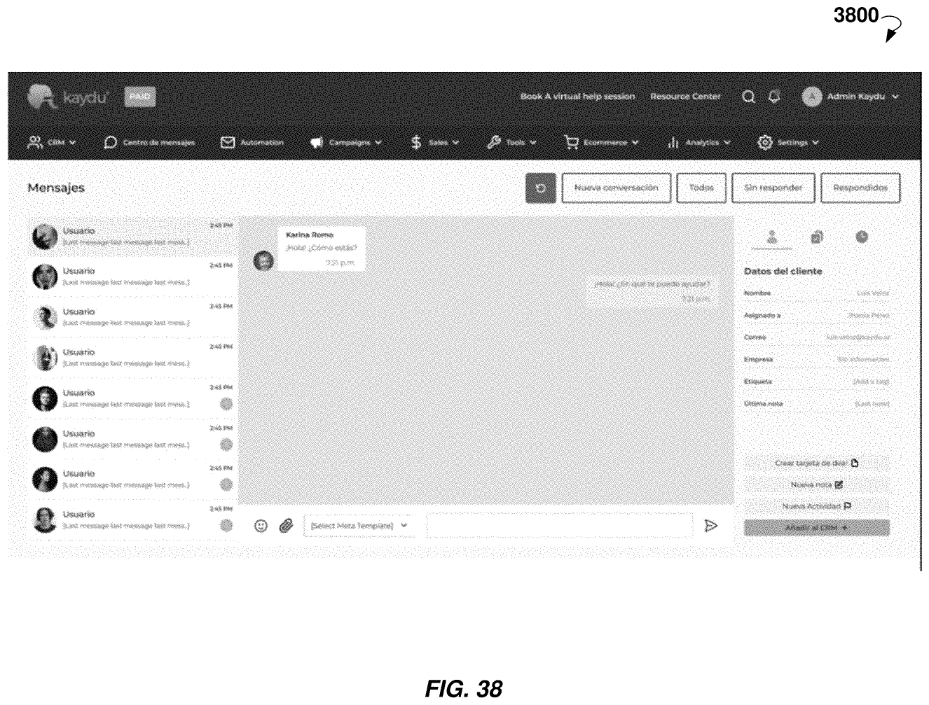

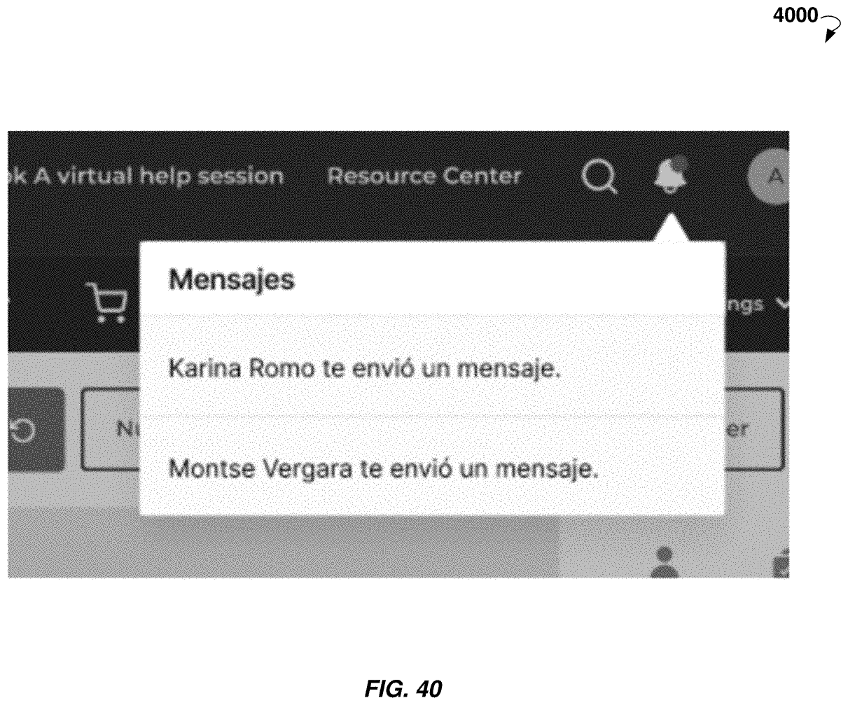

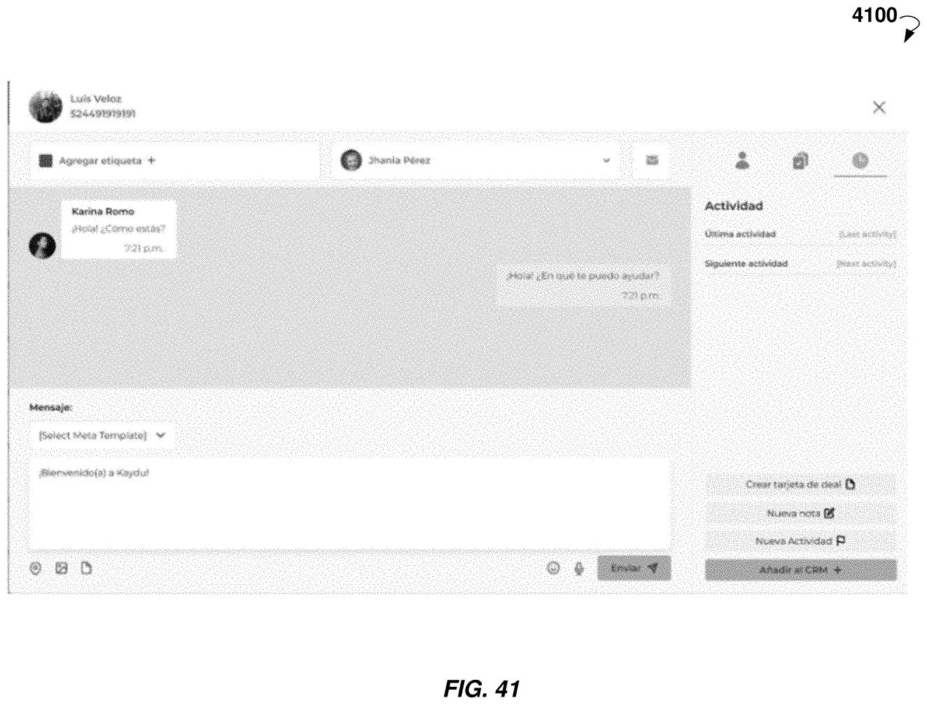

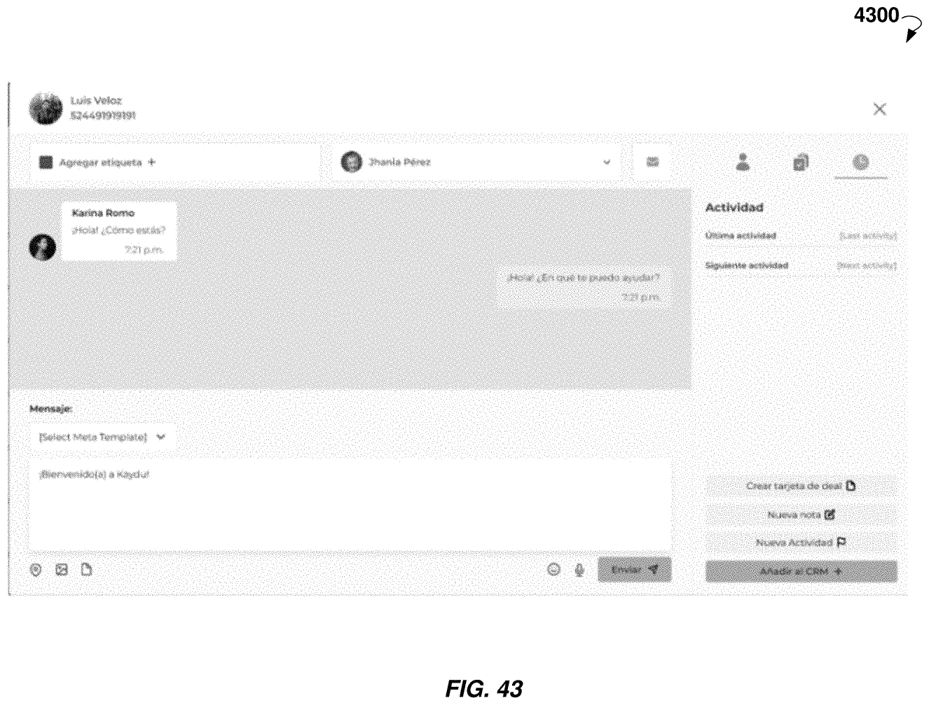

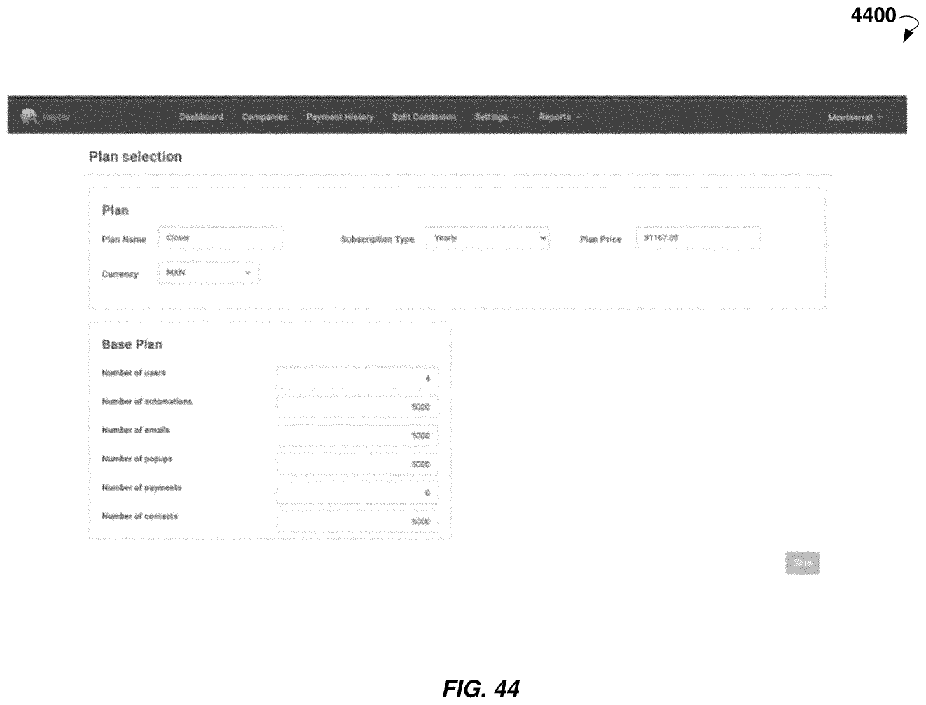

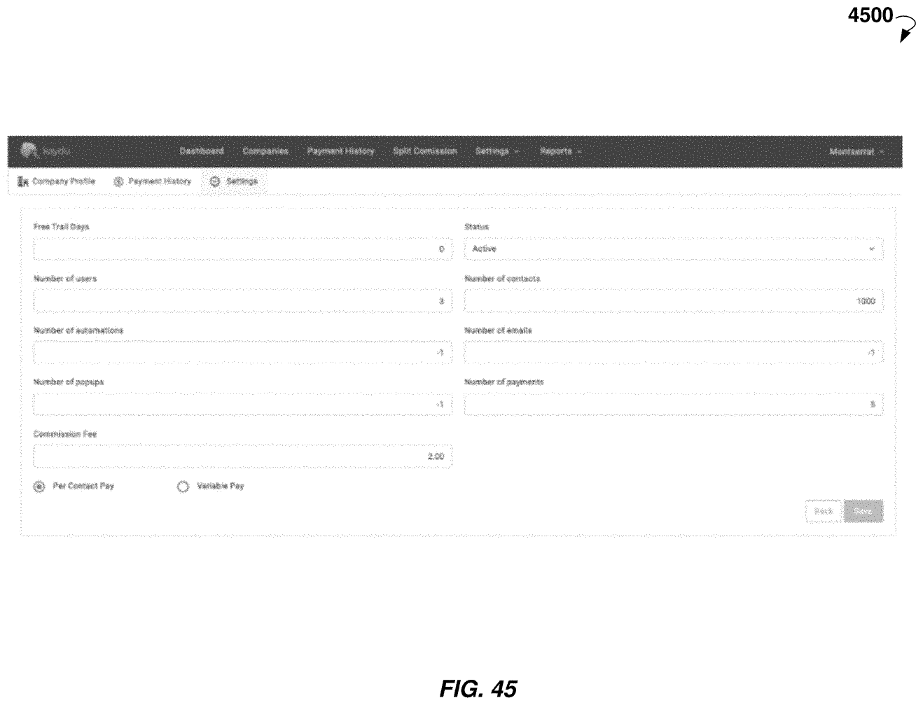

The builders of the system recognized that various users may use “non-traditional” communications packages. The platform 130 therefore includes a communications integration module illustrated in FIGS. 32-45. The integration module operates according to a logic in which the platform 130 makes an initial communication effort. When a contact exists within the CRM of the platform 130, and a message is sent through the platform 130, the communication works very well. However, when a person not yet present in the CRM package tries to send a message through a non-traditional package, the message is not recognized by the platform 130. In the following example, WhatsApp (a registered trademark) is used as an illustrative example of a non-traditional communications package.

Testing of the platform 130 showed that messages from different software packages did arrive in the system, and in the case of WhatsApp, the registered username of the WhatsApp sender was detected.

Accordingly, a procedure is needed that when a person, not registered in the CRM, sends a message to the platform 130, the message must reach the new message center.

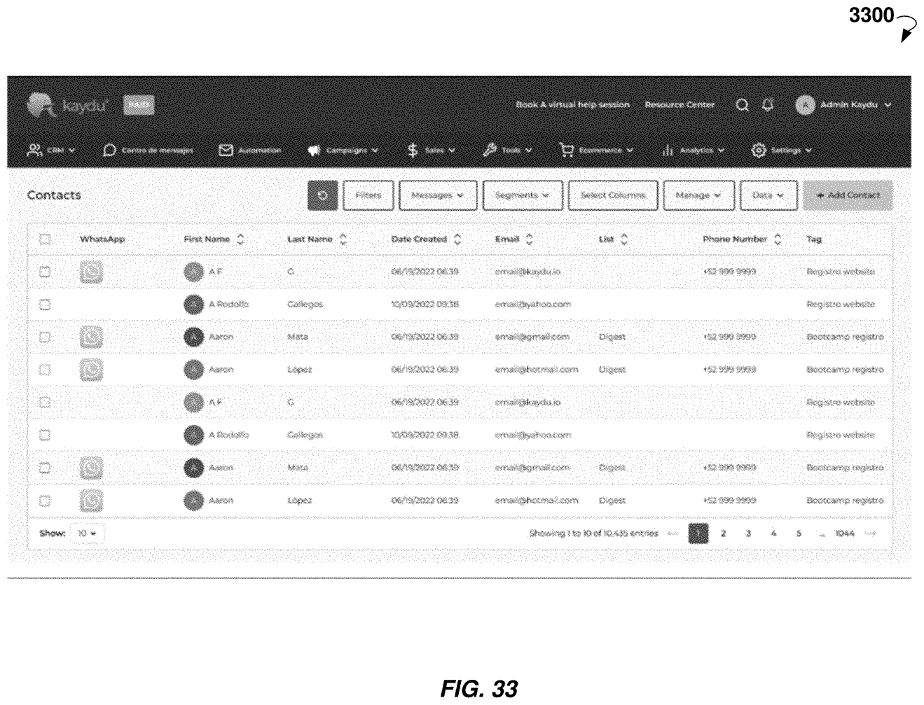

CRM: In the CRM module, in the contacts database, a request is entered to add a new column that will contain the WhatsApp icon for contacts who have a registered phone number in WhatsApp. The icon must be clickable and must show the contact's chat. See FIG. 33.

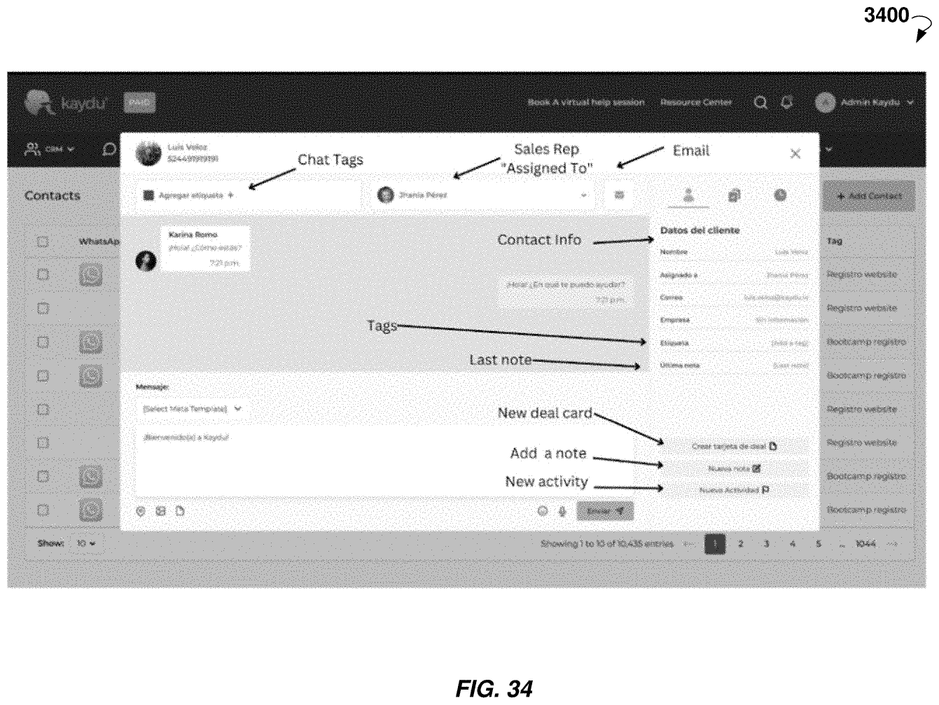

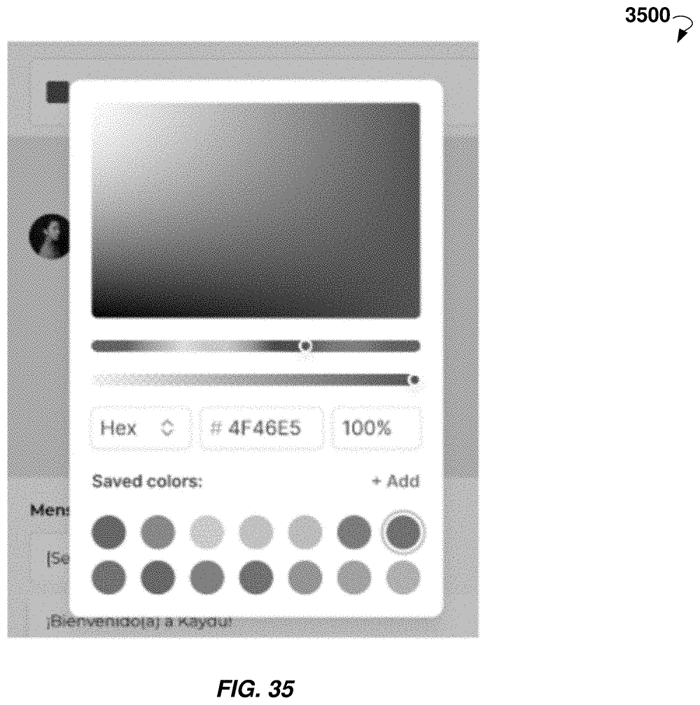

In the chat view, a user can select a WhatsApp template from those that have been approved by meta. See FIG. 34. At the top, chat tags can be added and associated with an assigned sales rep. Also, from this chat, the user can send an email and create new activities, notes, and deal cards without leaving the chat view. The forms used to create those items appear without the user leaving the chat view. This helps users work more efficiently. It is important to note that when creating the chat tags, the tags will only stay in the chat, and should be displayed in the contact information part, just below the last note, and should say “Chat tags”. The user can also choose the color of the label since it must include a color selector. See FIG. 35.

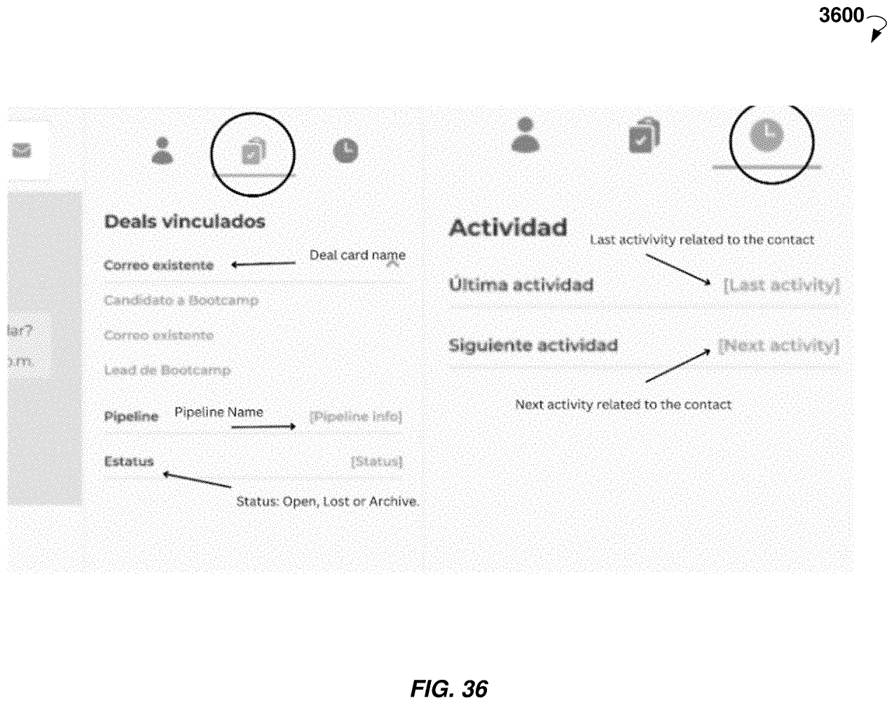

Referring now to FIG. 36, at the top right, there are three tabs. The first tab contains the contact information; such as first name, last name, company, email, contact tags, and the last existing note of the contact. This makes it easier for sales agents to have all the necessary information in one convenient location.

The second tab reveals information related to the sales module. The logic in this view is that it shows all the deal cards to which that contact is linked. Depending on the selected card, the system must indicate in which pipeline that deal card is located, and the current status of the deal.

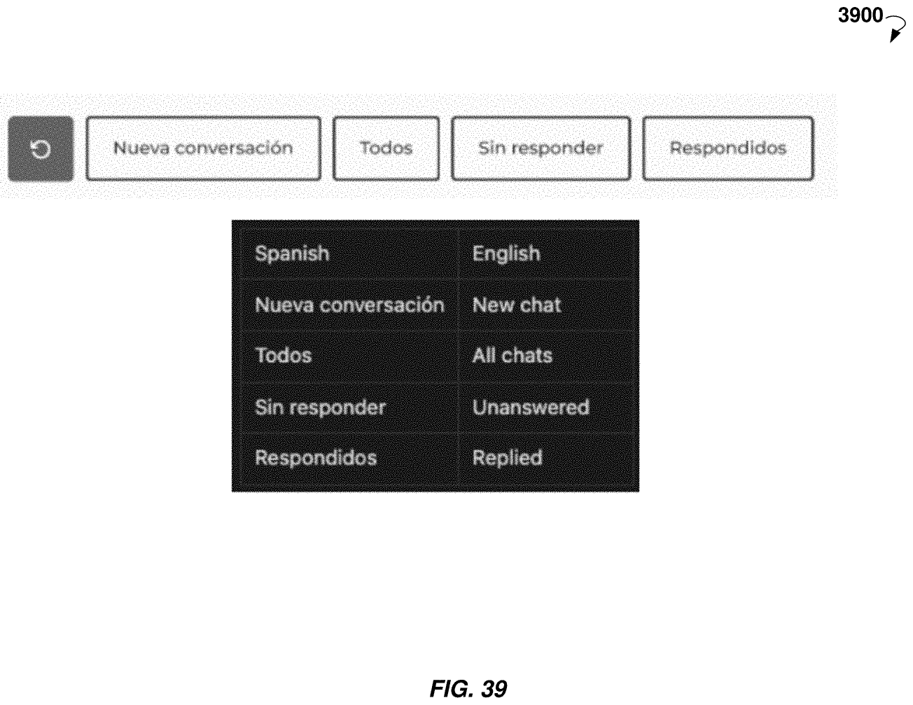

WhatsApp inbox: A tab is added between CRM and automation. The new tab is called “WhatsApp messages”. This feature shows an inbox view. This view will have the same chat functionality as in CRM, but in this view all the chats are shown so that the user can organize the chats. m, in the upper right part there will be three buttons that will act as conversation filters. Refer to FIG. 39. The first button is labeled “New chat” and allows the user to create a chat with a contact that exists in the CRM. The second button is labeled “All chats” and shows all the messages. The third button is labeled “Unanswered” and shows the messages that have not been answered by someone from the team. A fourth button, labeled “Replied”, shows the messages that have already been answered by someone from the team.

Notifications. At the top of the message notifications, the system must show a notification message such as: “Karina has sent you a message”. When that notification is clicked, the system utilizes the same logic as in CRM when clicking on the WhatsApp button, that is, the chat is displayed.

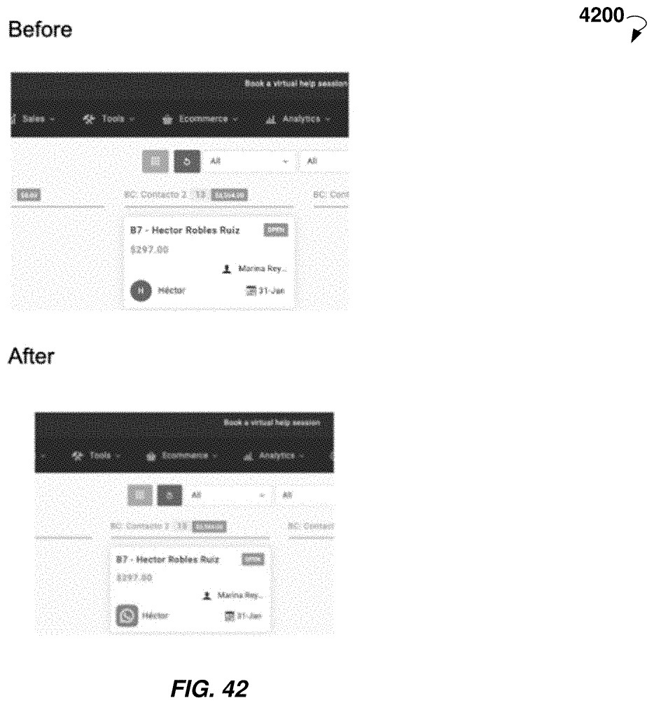

Deal Cards. Finally, the deal cards should appear with the circle with the initial of the contact for the WhatsApp icon, and when clicking on that icon the chat opens with all the functionality that has already been described. Before and after views of the deal cards 4200 are illustrated in FIG. 42.

In the super admin module of the system, the number of WhatsApp conversations option in both custom settings and in the subscriptions section can be displayed. In this way, from the super admin, we can enable or limit the number of new messages that can arrive per account. New messages are those sent by customers who are not in our CRM, that is, those who start the conversation.

The present technology is described above with reference to example embodiments. Therefore, other variations upon the example embodiments are intended to be covered by the present disclosure.

What is claimed is:

1. A system for accelerating sales by personalizing user interactions based on user behavior, the system being resident in a computer network and comprising:
mapping a process workflow for a purchase funnel using a plurality of templates wherein, the templates include at least one trigger condition and at least one personalized action corresponding to the at least one trigger condition;
tracking the user behavior;
based on the user behavior, determining that the at least one condition has been satisfied;
based on the determination, triggering the at least one personalized action;
receiving a user choice of at least one product offer;
in response to receiving the user choice, launching an ecommerce section;
collecting user payment information; and
finalizing a sale of the at least one product offer.

2. The system of claim 1, wherein:
the network in which the system resides supports a plurality of user devices.

3. The system of claim 1, wherein:
the system comprises a plurality of templates, the templates including landing pages, checkout pages, and cross-sell product offerings.

4. The system of claim 1, wherein:
the system comprises a plurality of templates, each template including a trigger condition and a personalized action corresponding to the trigger condition.

5. The system of claim 1, wherein:
the system tracks user behavior to determine that a trigger condition has been satisfied, the user behavior including at least one of reading an email, opening an item, engaging in a communication, and clicking on an item.

6. The system of claim 5, wherein:
the user behavior is tracked by creating an anonymous user assigned a user identifier, the user identifier including at least one of an IP, a browser identifier, and a database identifier.

7. The system of claim 1, wherein:
based on a determination that a trigger condition has been satisfied, the system triggers a personalized action in the form of a popup or an email offering the user one or more products.

8. The system of claim 1, wherein:
the system comprises one or more modules from the group of a user behavior tracking module, a customer relationship management module, an email marketing module, a popup marketing module, an automation module, and an ecommerce module.

9. The system of claim 1, wherein:
a customer relationship management module manages deals and sales for users, the deals being managed either automatically or manually based on user behavior.

10. The system of claim 9, wherein:
the deals are managed based on a determination that a particular user has performed a particular action, the particular action being at least one of visiting a certain webpage, attending an online seminar, watching a video online, and downloading a video.

11. The system of claim 9, wherein:
promotions are automated based on statistics associated with user behavior.

12. The system of claim 1, wherein:
an automation module sets conditions on automatically sending emails or presenting popups with offers to potential customers, when the conditions are met.

13. The system of claim 12, wherein:
the conditions include certain events, the events begin chosen from a plurality of triggering events, such as a user visiting a particular website or a lead score for a certain offer exceeding a predetermined threshold.

14. The system of claim 1, wherein:
the system includes a mechanism configured to assist a user of the system to create customized landing pages.

15. The system of claim 1, wherein:
the system includes a mechanism configured to integrate communications from a third party source into the system.
